(19) United States
(12) Patent Application Publication
(10) Pub. No.: US 2026/0363261 A1
(43) Pub. Date: Nov. 19, 2026

(54) NOVEL WHEY-DERIVED POWDERS ENRICHED WITH RESPECT TO WHEY LIPIDS AND SUITABLE FOR DRY-BLENDING, METHOD OF PRODUCTION, AND RELATED USES AND FOOD PRODUCTS

(71) Applicant: ARLA FOODS AMBA, Viby J (DK)

(72) Inventors: Hans BERTELSEN, Viby J (DK); Susanne Rossen ASCANIUS, Viby J (DK); Christoffer FRIIS, Viby J (DK); Maja Zacho BRUNHEDE, Viby J (DK)

(21) Appl. No.: 19/148,288

(22) PCT Filed: Jan. 25, 2024
(86) PCT No.: PCT/EP2024/051767

§ 371 Date: Jul. 15, 2025

(30) Foreign Application Priority Data
Jan. 25, 2023 (EP) 23153343.1

(51) Int. Cl. A23C 21/06; A23C 21/02; A23J 1/20

(52) U.S. Cl. CPC A23C 21/06; A23C 21/02; A23J 1/205

(57) ABSTRACT

The present invention pertains to a method of producing whey lipid powders having both a high content of bioactive components such as native IgG and native lactoferrin and at the same time a sufficient microbial quality that makes the powders useful for production of e.g. infant formula powders by dry-blending. The invention also pertains to a whey-derived powder enriched with respect to whey lipid and to processes of using the whey-derived powder and to nutritional products containing the whey-derived powder.

### FIELD OF THE INVENTION

The present invention pertains to a method of producing whey lipid powders having both a high content of bioactive components such as native IgG and native lactoferrin and at the same time a sufficient microbial quality that makes the powders useful for production of e.g. infant formula powders by dry-blending. The invention also pertains to a whey-derived powder enriched with respect to whey lipid and to processes of using the whey-derived powder and to nutritional products containing the whey-derived powder.

### BACKGROUND

Production of powdered food products, such as e.g. infant formula products, by dry-blending of the appropriate ingredients is a cost-effective approach and consumes less energy than wet-blending approaches wherein all ingredients are dissolved in water and subsequently dried.

US 2017/000182 A1 discloses nutritional compositions such as an infant formula comprising phospholipids in an amount of at least 300 mg/L in the presence of bioactive compounds such as immunoglobulins, lactoferrin, gangliosides, sialic acid, growth factors, lactoperoxidase, lysozyme, cytokines, and nucleosides.

US 2016/158287 discloses nutritional compositions, e.g. in the form of infant formulas, containing whey protein/milk protein concentrate solids rich in phospholipids, rich in MFGM for use in the prophylaxis and prevention of infectious morbidity, especially otitis.

### SUMMARY OF THE INVENTION

The present inventors have found that conventional powder ingredients suitable for preparation of powdered nutritional products by dry-blending typically have been subjected to severe processing conditions to reduce the microbial content of the powder ingredients to a minimum. This is particularly relevant in relation to dry-blended nutritional powders for infant nutrition (e.g. infant formulas) and to clinical nutrition where the requirements in relation to the microbiology of the products are very strict. The inventors have observed that the down-side of the severe processing conditions is that valuable nutritional components are lost due to the harsh processing when producing the powder ingredients. The inventors have furthermore found that it particularly is a problem for whey lipid-enriched whey products, which often risk capturing the microorganisms of the whey together with the whey lipids.

However, the inventors have discovered that, surprisingly, microbiologically safe whey lipid powder ingredients of improved bioactivity can be prepared from whey using special heating conditions as the last heat-treatment step prior to the drying that leads to the formation of the powder ingredient. Additionally, the inventors have found that, surprisingly, addition of carbohydrates, e.g. in the form of lactose, to such whey lipid-enriched whey products prior to the final heat-treatment also improves the content of bioactive components in the resulting powder.

The inventors have furthermore found that it is particularly preferred to combine the special heat-treatment with addition of carbohydrate prior to the heat-treatment.

Therefore, an aspect of the invention pertains to a method of preparing a whey-derived powder enriched with respect to whey lipid, which whey-derived powder is suitable for preparation of an infant formula powder by dry-blending, the method comprising the steps of:
a) providing a non-sterile whey lipid concentrate, the whey lipid concentrate having:
   a content of phospholipid of at least 1.5% w/w relative to total solids,
   a weight ratio between phospholipid and total protein of at least 0.04,
   a content of carbohydrate of at most 70% w/w relative to TS,
   a total solids content of 1-50% w/w,
   preferably, a content of native immunoglobulin G of 1-17% w/w relative to total protein,
   preferably, a content of native lactoferrin of 0.1-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction,
c) drying a liquid composition comprising at least lipid and protein of the heat-treated whey lipid concentrate obtained from step b).

Another aspect of the invention pertains to a whey-derived powder enriched with respect to whey lipid, the whey-derived powder having:
a content of phospholipid of at least 1.5% w/w relative to total solids,
a weight ratio between phospholipid and total protein of at least 0.04,
a content of carbohydrate of at most 70% w/w relative to TS, preferably wherein lactose comprises at least 50% w/w of the carbohydrate,
a total solids content of at least 92% w/w,
preferably, a content of native immunoglobulin G of 1-17% w/w relative to total protein,
preferably, a content of native lactoferrin of 0.1-1.5% w/w relative to total protein, said whey-derived powder having one or more of, and more preferably all of, the following characteristics:
a total plate count of at most 1000000 CFU/100 g the whey-derived powder,
Cronobacter species are absent in at least 30 samples of 10 g of the whey-derived powder,
Salmonella species are absent in at least 30 samples of 25 g of the whey-derived powder, and
Enterobacteriaceae species are absent in at least 10 samples of 10 g of the whey-derived powder.

A further aspect of the invention pertains to the tse of the whey-derived powder described herein as a food ingredient, for preparing a nutritional product, preferably for paediatric nutrition, and more preferably an infant formula product in powder form, preferably wherein the nutritional product is prepared by dry-blending the whey-derived powder with:
one or more additional powder ingredient(s), and
optionally, further powder ingredient comprising of probiotic bacteria.

A further aspect of the invention pertains to a process of producing a nutritional powder, preferably for paediatric nutrition, and more preferably an infant formula, the process comprising dry-blending the whey-derived powder according to the present invention with:
one or more additional powder ingredient(s), and
optionally, a further powder ingredient comprising of probiotic bacteria, preferably, wherein the one or more additional powder ingredient(s) have the following characteristics:
a total plate count of at most 1000000 CFU/100 g ingredient powder, and more preferably at most 50000 CFU/100 g ingredient powder,
Cronobacter species are absent in at least 30 samples of 10 g ingredient powder,
Salmonella species are absent in at least 30 samples of 25 g ingredient powder, and
Enterobacteriaceae species are absent in at least 10 samples of 10 g ingredient powder.

Yet an aspect of the invention pertains to a nutritional powder which is a dry-blend of the whey-derived powder according to the present invention and one or more additional powder ingredient(s), and optionally a further powder ingredient comprising of probiotic bacteria, preferably wherein the combination of the one or more additional ingredients have the following characteristics:
a total plate count of at most 1000000 CFU/100 g ingredient powder, and more preferably at most 50000 CFU/100 g ingredient powder,
Cronobacter species are absent in at least 30 samples of 10 g ingredient powder,
Salmonella species are absent in at least 30 samples of 25 g ingredient powder, and
Enterobacteriaceae species are absent in at least 10 samples of 10 g ingredient powder.

### DETAILED DESCRIPTION

As mentioned above, an aspect of the invention pertains to a method of preparing a whey-derived powder enriched with respect to whey lipid, which whey-derived powder is suitable for preparation of an infant formula powder by dry-blending, the method comprising the steps of:
a) providing a non-sterile whey lipid concentrate, preferably in which the whey lipid originates from a retentate obtained by membrane filtration of whey, the whey lipid concentrate having:
   a content of phospholipid of at least 1.5% w/w relative to total solids,
   a weight ratio between phospholipid and total protein of at least 0.04,
   a content of carbohydrate of at most 70% w/w relative to TS,
   a total solids content of 1-50% w/w,
   preferably, a content of native immunoglobulin G of 1-17% w/w relative to total protein,
   preferably, a content of native lactoferrin of 0.1-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction,
c) drying a liquid composition comprising at least lipid and protein of the heat-treated whey lipid concentrate obtained from step b).

In the context of the present invention the terms “whey-derived powder” and “whey-derived powder enriched with respect to whey lipid” pertain to the product of the present invention. The protein and lipid components of the whey-derived powder are preferably proteins and lipids found in whey of mammal milk. The whey-derived powder has a weight ratio between lipids and total protein that is at least 0.15 which is higher than what is normally found in whey or whey protein concentrates.

In the context of the present invention the term “whey lipid” refers to lipids that are found in mammal whey. Whey lipid include milk phospholipids, milk triglycerides, gangliosides and other milk fat membrane components.

In the context of the present invention the term “whey” relates to the liquid composition, which is left when casein has been precipitated from milk. Casein precipitation may e.g. be accomplished by acidification of milk and/or by use of rennet enzyme. Several types of whey exist, such as “sweet whey”, which is the whey product produced by rennet-based precipitation of ca-sein, and “acid whey” or “sour whey”, which is the whey product produced by acid-based precipitation of casein. Acid-based precipitation of casein may e.g. be accomplished by addition of food acids or by means of bacterial cultures.

In the context of the present invention the term “dry-blending” refers to a method of preparing powdered food products in which the individual ingredients are provided in dry form, typically as powders, and then blended under dry conditions, i.e. without addition of water or water-rich ingredients, to form the final food product. Dry-blending is typically performed under very clean conditions, often aseptically, and therefore does not require a pasteurizing heat-treatment after dry-blending. Additionally, contrary to wet-blending methods, dry-blending does not require high energy drying-steps for water removal. Wet-mixing furthermore requires a second pasteurization step which is prone to cause further protein denaturation and degrade other heat-sensitive components of the powdered food products. The higher content of denatured proteins in powdered food products prepared by wet-blending may furthermore give rise to increased viscosity when the powdered food is resuspended in water and may make the resulting liquid beverage less drinkable.

In the context of the present invention the term “whey lipid concentrate” pertains to a liquid isolate of whey lipids of whey, e.g. in the form of a retentate prepared by lipid-retaining micro-filtration of a whey feed. The whey feed may e.g. be crude whey, whey from which large cheese particles have been removed by coarse filtration or by centrifugation, or a whey protein concentrate prepared by e.g. ultrafiltration e.g. in combination with diafiltration. Preferred whey lipid concentrates are e.g. prepared according to steps a), b) of PCT/EP2022/070107 (published as International patent application no.: WO2023001783A1) followed by the MF-based germ filtration of step c) of PCT/EP2022/070107.

In the context of the present invention the term “native immunoglobulin G” pertains to immunoglobulin G in the conformation in which it is found in unheated, mammal milk. Immunoglobulin G as such is well-known to the skilled person. Immunoglobulins form an important component of the immunological activity found in mammal milk and are central to the immunological link that occurs when the mother transfers passive immunity to an infant. Native immunoglobulins are considered a valuable components in e.g. infant formulas and contributes to the healthy development of the infant.

In the context of the present invention the term “native lactoferrin” pertains to lactoferrin in the conformation in which it is found in unheated, mammal milk. Lactoferrin as such is well-known to the skilled person. Like IgG, native lactoferrin is considered a valuable component in e.g. infant formulas and contributes to the healthy development of the infant.

In the context of the present invention “% w/w TS” means “% w/w relative to total solids” i.e. weight percentage relative to total solids.

As mentioned above, the inventors have discovered that, surprisingly, that microbiologically safe powder whey lipid ingredients having improved bioactivity can be prepared from whey using method that uses special heating conditions as the last heat-treatment step prior to drying that leads to the formation of the powder ingredient. Additionally, the inventors have found that, surprisingly, addition of carbohydrates, e.g. in the form of lactose, to such whey lipid-enriched whey products prior to the final heat-treatment also improves the content of bioactive components in the resulting powder. The inventors have furthermore found that it is particularly preferred to combine the special heat-treatment with addition of carbohydrate prior to the heat-treatment.

In some preferred embodiments of the present invention:
the whey lipid concentrate comprises lactose in an amount of 25-70% w/w TS, and/or
the heat-treatment of step b) involves heating by direct heating, preferably involving heating by steam infusion, and preferably wherein any heating performed when the whey lipid concentrate has a temperature above 63 °C is performed by direct heating, preferably by steam infusion.

In even more preferred embodiments of the present invention:
the whey lipid concentrate comprises lactose in an amount of 25-70% w/w TS, and
the heat-treatment of step b) involves heating by direct heating, preferably involving heating by steam infusion, and preferably wherein any heating performed when the whey lipid concentrate has a temperature above 63 °C is performed by direct heating, preferably by steam infusion.

In the context of the present invention, the term “high carbohydrate variant of the invention” characterises embodiments of the invention wherein the whey lipid concentrate and whey-derived powder contain at least 25% w/w carbohydrate relative to TS.

In the context of the present invention, the term “low carbohydrate variant” characterises embodiments of the invention wherein the whey lipid concentrate and whey-derived powder contain less than 25% w/w carbohydrate relative to TS.

In some preferred embodiments of the present invention the whey lipid concentrate comprises phospholipid in an amount of at least 1.5% w/w total solids, more preferably at least 3% w/w TS, even more preferably at least 5% w/w TS, and most preferably at least 6% w/w TS.

In other preferred embodiments of the present invention the whey lipid concentrate comprises phospholipid in an amount of at 4.0-12% w/w TS, more preferably 4.5-10% w/w TS, even more preferably 5.0-9% w/w TS, and most preferably 5.5-8.5% w/w TS. These range are particularly suitable in relation to the low carbohydrate variant of the invention.

In some preferred embodiments of the present invention the whey lipid concentrate comprises phospholipid in an amount of at 1.5-10% w/w TS, more preferably 1.6-8% w/w TS, even more preferably 1.8-6% w/w TS, and most preferably 3-5.5% w/w TS. These range are particularly suitable in relation to the high carbohydrate variant of the invention.

The content of total lipids of the whey lipid concentrate is typically exceeds the content of phospholipid. In some preferred embodiments of the present invention, the whey lipid concentrate comprises total lipid in an amount of at least 3% w/w TS, more preferably at least 6% w/w TS, even more preferably at least 10% w/w TS, and most preferably at least 16% w/w TS.

In other preferred embodiments of the present invention the whey lipid concentrate comprises lipid in an amount of at 8-30% w/w total solids, more preferably 10-26% w/w TS, even more preferably 12-24% w/w TS, and most preferably 15-22% w/w TS. These range are particularly suitable in relation to the low carbohydrate variant of the invention.

In further preferred embodiments of the present invention, the whey lipid concentrate comprises lipid in an amount of at 3.0-20% w/w total solids, more preferably 3.5-16% w/w TS, even more preferably 4-12% w/w TS, and most preferably 7-11% w/w TS. These range are particularly suitable in relation to the high carbohydrate variant of the invention.

The weight ratio between phospholipid and total lipid of the whey lipid concentrate is typically less than 1. In preferred embodiments of the present invention wherein the whey lipid concentrate has a weight ratio between phospholipid and total lipid of 0.20-0.50, more preferably 0.25-0.45, and most preferably 0.30-0.40.

The whey lipid concentrate preferably has a weight ratio between phospholipid and total protein of at least 0.04, more preferably at least 0.06, even more preferably at least 0.08, and most preferably at least 0.09.

In some preferred embodiments of the present invention the whey lipid concentrate has a weight ratio between phospholipid and total protein in the range of 0.04-0.25, more preferably 0.07-0.20, even more preferably 0.08-0.17, and most preferably 0.09-0.15.

The whey lipid concentrate typically contains protein and preferably comprises total protein in an amount of at least 20% w/w TS, and most preferably at least 25% w/w TS.

In some preferred embodiments of the present invention the whey lipid concentrate comprises total protein in an amount in the range of 20-80% w/w TS, and most preferably at least 25-75% w/w TS.

In other preferred embodiments of the present invention, the whey lipid concentrate comprises total protein in an amount of at least 60% w/w TS, and most preferably at least 65% w/w TS. Preferably, the whey lipid concentrate comprises total protein in an amount in the range of 60-80% w/w TS, more preferably 65-80% w/w TS, and most preferably 70-75% w/w TS.

Embodiments wherein the whey lipid concentrate comprises total protein in an amount of at least 60% w/w TS are particularly suitable in relation to the low carbohydrate variant of the invention.

In further preferred embodiments of the present invention the whey lipid concentrate comprises total protein in an amount less than 60% w/w TS, more preferably at most 55 w/w TS, and most preferably at most 50 w/w TS. Preferably, the whey lipid concentrate comprises total protein in an amount in the range of 20-60% w/w TS, more preferably 20-55% w/w TS, and most preferably 20-50% w/w TS. In other preferred embodiments of the present invention the whey lipid concentrate comprises total protein in an amount in the range of 22-50% w/w TS, more preferably 24-45% w/w TS, and most preferably 25-40% w/w TS.

Embodiments wherein the whey lipid concentrate comprises total protein in an amount less than 60% w/w TS are particularly suitable in relation to the high carbohydrate variant of the invention.

As mentioned above, the whey lipid concentrate typically comprises carbohydrate in an amount of 0-70% w/w TS.

Lactose is an important carbohydrate for e.g. infant nutrition and it is often preferred that lactose is present in the whey lipid concentrate in an amount of at least 50% w/w relative to the total amount of carbohydrate, more preferably at least 70% w/w, even more preferably at least 80% w/w, and most preferably at least 90% w/w relative to the total amount of carbohydrate. It may even be preferred that substantially all carbohydrate of the whey lipid concentrate is lactose, and it may therefore be preferred that lactose is present in the whey lipid concentrate in an amount of at least 93% w/w relative to the total amount of carbohydrate, more preferably at least 96% w/w, even more preferably at least 98% w/w, and most preferably at least 99% w/w relative to the total amount of carbohydrate.

In some preferred embodiments of the present invention the whey lipid concentrate comprises lactose in an amount of 0-70% w/w TS.

In other preferred embodiments of the present invention, the whey lipid concentrate comprises carbohydrate in an amount of less than 25% w/w TS, more preferably at most 15% w/w TS, even more preferably at most 6% w/w TS, and most preferably at most 2% w/w TS.

For example, the whey lipid concentrate may comprises lactose in an amount of less than 25% w/w TS, more preferably at most 15% w/w TS, even more preferably at most 6% w/w TS, and most preferably at most 2% w/w TS.

In further preferred embodiments of the present invention, particularly useful for the high carbohydrate variant of the invention, the whey lipid concentrate comprises carbohydrate in an amount of 25-70% w/w TS, more preferably 35-70% w/w TS, and most preferably 40-70% w/w TS.

It is even more preferred that the whey lipid concentrate comprises carbohydrate in an amount of 45-70% w/w TS, more preferably 50-70% w/w TS, and most preferably 50-65% w/w TS.

In some preferred embodiments of the present invention the whey lipid concentrate comprises lactose in an amount of 25-70% w/w TS, more preferably 35-70% w/w TS, and most preferably 40-70% w/w TS.

In other preferred embodiments of the present invention, the whey lipid concentrate comprises lactose in an amount of 45-70% w/w TS, more preferably 50-70% w/w TS, and most preferably 50-65% w/w TS.

The inventors have seen indications that whey-derived powder of the invention have an improved usability, particularly in terms of wettability and dispersibility, when dry-blended powders containing the whey-derived powder is mixed with water or aqueous liquids, particularly in terms of wettability and dispersibility. This appears to be particularly pronounced in relation to the high carbohydrate variant of the invention.

In some preferred embodiments of the present invention, the whey lipid concentrate comprises lactose in an amount of 2-24% w/w, more preferably 3-24% w/w, and most preferably 4-24% w/w.

In other preferred embodiments of the present invention the whey lipid concentrate comprises lactose in an amount of 5-24% w/w, more preferably 5-20% w/w, and most preferably 8-18% w/w.

In some preferred embodiments of the present invention the whey lipid concentrate comprises carbohydrate in an amount of 3-24% w/w, more preferably 3-24% w/w, and most preferably 4-24% w/W.

The whey lipid concentrate may preferably comprises carbohydrate in an amount of 5-25% w/w, more preferably 5-20% w/w, and most preferably 8-18% w/w.

In other preferred embodiments of the present invention the whey lipid concentrate comprises carbohydrate in an amount of at most 2% w/w, more preferably at most 1% w/w, even more preferably at most 0.5% w/w, and most preferably at most 0.1% w/w.

For example, the whey lipid concentrate may comprise lactose in an amount of at most 2% w/w, more preferably at most 1% w/w, even more preferably at most 0.5% w/w, and most preferably at most 0.1% w/w.

The whey lipid concentrate is typically not sterile and therefore contains microorganisms.

In some preferred embodiments of the present invention, the whey lipid concentrate has a total plate count of more than 100 colony forming units (CFU) per kg TS, more preferably at least 500 CFU/kg TS, even more preferably at least 2000 CFU/kg TS, and most preferably at least 5000 CFU/kg TS.

In further preferred embodiments of the present invention the whey lipid concentrate has a total plate count of 1 colony forming units (CFU) per g TS, more preferably at least 10 CFU/g TS, even more preferably at least 30 CFU/g TS, and most preferably at least 100 CFU/g TS. It may for example be preferred that the whey lipid concentrate has a total plate count of more than 500 colony forming units (CFU) per g TS, more preferably at least 1000 CFU/g TS, even more preferably at least 2000 CFU/g TS, and most preferably at least 5000 CFU/g TS.

In some preferred embodiments of the present invention the whey lipid concentrate has a total plate count of 1-5*10⁷ CFU/g TS, more preferably 10-5*10⁶, and most preferably 100-1*10⁶ CFU/g TS. It may for example be preferred that the whey lipid concentrate has a total plate count of 501-5*10⁷ CFU/g TS, more preferably 1000-5*10⁶, and most preferably 2000-1*10⁶ CFU/g TS.

It is often preferred that the whey lipid concentrate contains has an even lower total plate count. In some preferred embodiments of the present invention the whey lipid concentrate has a total plate count of 1-5*10⁶ CFU/g TS, more preferably 10-5*10⁵ CFU/g TS, and most preferably 100-1*10⁵ CFU/g TS.

The whey lipid concentrate preferably comprises total solids in an amount of 2-50% w/w, more preferably 5-45%, even more preferably 8-40% w/w, and most preferably 10-35% w/w.

In some preferred embodiments of the present invention the whey lipid concentrate comprises total solids in an amount of 2-25% w/w, more preferably 5-20%, even more preferably 8-20% w/w, and most preferably 10-18% w/w. These ranges are often preferred when the resulting whey-derived powder should be used for preparation of infant formula products by dry-blending.

In other preferred embodiments of the present invention, the whey lipid concentrate comprises total solids in an amount of 5-45% w/w, more preferably 10-40%, and most preferably 15-35% w/w.

The matter of the whey lipid concentrate, the whey-derived powder and the nutritional product that does not consist of solids is preferably water.

The preferably has a considerable content of bioactive components such as e.g. immunoglobulins and lactoferrin.

In some preferred embodiments of the present invention the whey lipid concentrate has a content of native immunoglobulin G of 5-17% w/w relative to total protein, more preferably 7-16% w/w, even more preferably 8-15% w/w, and most preferably 10-15% w/w relative to total protein.

In other preferred embodiments of the present invention the whey lipid concentrate has a content of native immunoglobulin G of 7-17% w/w relative to total protein, more preferably 8-17% w/w, and most preferably 10-17% w/w relative to total protein.

It is often preferred that the weight ratio between native immunoglobulin G and total immunoglobulin G of the whey lipid concentrate is at least 0.5, more preferably at least 0.7, even more preferably at least 0.8, and most preferably at least 0.9.

It is even feasible and often preferred that the weight ratio between native immunoglobulin G and total immunoglobulin G of the whey lipid concentrate is at least 0.95. This can e.g. be accomplished by gentle treatment of the whey feed from which the whey lipid concentrate is prepared

In some preferred embodiments of the present invention, the whey lipid concentrate has a content of native lactoferrin of 0.1-1.2% w/w relative to total protein, more preferably 0.2-1.2% w/w, even more preferably 0.3-1.2% w/w, and most preferably 0.3-1.1% w/w relative to total protein.

In other preferred embodiments of the present invention, the whey lipid concentrate has a content of native lactoferrin of 0.2-1.5% w/w relative to total protein, more preferably 0.3-1.5% w/w, even more preferably 0.4-1.5% w/w, and most preferably 0.5-1.5% w/w relative to total protein. These embodiments are e.g. feasible when the whey lipid concentrate has been prepared from whey that has only subjected to very low heat-treatments (e.g. according to Examples 4 or 5).

It is normally preferred that the weight ratio between native lactoferrin and total lactoferrin of the whey lipid concentrate is at least 0.3, more preferably at least 0.4, even more preferably at least 0.5, and most preferably at least 0.6.

It is even feasible and often preferred that the weight ratio between native lactoferrin and total lactoferrin of the whey lipid concentrate is at least 0.8. This can e.g. be accomplish by gentle treatment of the whey feed from which the whey lipid concentrate is prepared.

In some embodiments of the invention, the whey lipid concentrate comprises at most 10% w/w casein relative to the total amount of protein, preferably at most 5% w/w, more preferably at most 1% w/w, and even more preferably at most 0.5% casein relative to the total amount of protein.

In some preferred embodiments of the present invention, the whey lipid concentrate comprises a total amount of beta-lactoglobulin in the range of 10-45% w/w relative to total protein, more preferably 15-40% w/w, even more preferably 20-40% w/w, and most preferably 25-35% w/w relative to total protein.

In some preferred embodiments of the present invention, the whey lipid concentrate comprises a total amount of alpha-lactalbumin in the range of 0-15% w/w relative to total protein, more preferably 0.1-10% w/w, even more preferably 0.3-9% w/w, and most preferably 0.5-7% w/w relative to total protein.

Alternatively but also preferred, the whey lipid concentrate comprises a total amount of alpha-lactalbumin in the range of 1-10% w/w relative to total protein, more preferably 1-9% w/w, even more preferably 2-8% w/w, and most preferably 3-7% w/w relative to total protein.

In some preferred embodiments of the present invention the whey lipid concentrate comprises a total amount of caseinomacropeptide in the range of 0-10% w/w relative to total protein, more preferably 1-8% w/w, even more preferably 2-7% w/w, and most preferably 3-7% w/w relative to total protein.

Alternatively, but also preferred, the whey lipid concentrate comprises a total amount of caseinomacropeptide in the range of 0-9% w/w relative to total protein, more preferably 0.1-7% w/w, even more preferably 0.3-5% w/w, and most preferably 0.5-3% w/w relative to total protein.

In further preferred embodiments of the present invention, typically if the whey lipid concentrate is based on casein whey and/or has been subjected to extensive diafiltration, the whey lipid concentrate comprises a total amount of caseinomacropeptide in the range of 0-5% w/w relative to total protein, more preferably 0-3% w/w, even more preferably 0-1% w/w, and most preferably 0-0.5% w/w relative to total protein.

In some preferred embodiments of the present invention the whey lipid concentrate comprises a total amount of osteopontin in the range of 0.9-5% w/w relative to total protein, more preferably 1.0-4% w/w, even more preferably 1.1-3% w/w, and most preferably 1.1-1.7% w/w relative to total protein.

In other preferred embodiments of the present invention, the whey lipid concentrate comprises a total amount of osteopontin in the range of 2.0-5% w/w relative to total protein, more preferably 2.2-4.5% w/w, even more preferably 2.5-4.0% w/w, and most preferably 3.0-3.7% w/w relative to total protein.

The inventors have found that it often is preferred to use whey lipid concentrate having a considerably content of total sialic acid and gangliosides.

In some preferred embodiments of the present invention the whey lipid concentrate has a content of total sialic acid in an amount of 1.7-3.5 g per 100 g protein, more preferably 2.0-3.3 g per 100 g protein and most preferred 2.4-2.9 g per 100 g protein.

In some preferred embodiments of the present invention the whey lipid concentrate has a content of ganglioside in an amount of 2500-5000 mg/kg protein, and most preferred 3500-4500 mg/kg protein.

The ganglioside content can be analyzed with a LC-MS method, GANGLIO-r-LC-TOF.

In some preferred embodiments of the present invention the whey lipid concentrate has an ash content of 0.3-6% w/w relative to total solids, more preferably 0.5-5% w/w, even more preferably 1.0-4% w/w, and most preferably 1.2-3.5% w/w relative to total solids.

In other preferred embodiments of the present invention the whey lipid concentrate has an ash content of 0.3-2% w/w relative to total solids, more preferably 0.4-1.5% w/w, and most preferably 0.5-1.0% w/w relative to total solids.

The inventors have furthermore found that supplementation of Fe(II) tend to stabilise the native lactoferrin in whey lipid concentrates during the heat-treatment of step b).

In some preferred embodiments of the present invention the whey lipid concentrate has a content of Fe(II) in an amount of 2-50 mg per kg protein, more preferably 3-30 mg per kg protein, even more preferably 4-15 mg per kg protein, and most preferably 5-10 mg per kg protein.

A broad range of pH values may be employed. However, preferably, the whey lipid concentrate has pH of 4.0-8, more preferably 5.5-7.5, even more preferably 5.7-7.0, and most preferably 5.9-6.6.

The temperature of the whey lipid concentrate prior to step b) is typically selected to avoid or at least limit protein denaturation. Preferably, the whey lipid concentrate has a temperature in the range of 1-59 °C, more preferably 2-20 °C, even more preferably 3-15 °C, and most preferably 3-10 °C.

The whey lipid concentrate of preferably prepared using a minimum of protein-denaturing heat-treatments, meaning reducing or even avoiding temperatures above approx. 62 °C.

Such heat-treatment may e.g. lead to the denaturation of beta-lactoglobulin (BLG) and the inventors have found that it is beneficial to operate with a whey lipid concentrate that has a relatively low weight ratio between denatured BLG and total protein as this ratio indicates the level of heat-stress that has been applied during the processing of the whey feed into to the whey lipid concentrate.

It is normally preferred that the weight ratio between denatured BLG and total protein of the whey lipid concentrate is at most 0.3, more preferably at most 0.25, even more preferably at most 0.20, and most preferably at most 0.15.

Often it is even preferred that the whey lipid concentrate has a weight ratio between denatured BLG and total protein of the whey lipid concentrate is at most 0.12, more preferably at most 0.10, even more preferably at most 0.08, and most preferably at most 0.06.

The whey lipid concentrate is typically prepared from a whey feed by gentle separation of the whey lipids and the accompanying proteins.

The whey from which at least the lipid and protein of the whey feed originate is preferably prepared from ruminant milk and more preferably from bovine milk.

The whey feed is preferably prepared without drying the lipid and whey protein originating from whey.

The whey feed preferably has a degree of BLG denaturation of at most 30%, more preferably at most 20%, even more preferably at most 10% and most preferably at most 5%. The degree of BLG denaturation is determined as the percentage of total BLG that is not native BLG. Total BLG and native BLG can be determined by HPLC under reducing conditions for total BLG and under non-reducing conditions for native BLG.

In some preferred embodiments of the present invention the whey feed comprises or even consists of whey.

The whey is preferably a sweet whey, i.e. obtained from rennet-based casein coagulation, e.g. during cheese production, or an acid whey, i.e. from acid-based casein coagulation, e.g. from the production of caseinate.

The whey is preferably the whey resulting from casein precipitation of whole milk, skimmed milk, or a mixture thereof.

In other preferred embodiments of the present invention the whey feed comprises or even consists of a protein concentrate of whey.

In the context of the present invention a “protein concentrate” of a whey is a liquid composition in which at least the lipid and protein originate from the whey but which has a higher protein content relative to total solids than the whey. Preferably, substantially all solids of the protein concentrate originate from whey.

It is often preferred that the whey feed has preferably not been subjected to processing which gives it a reduced content of total phospholipid relative to total solids relative to the whey from which it originates. In this way a higher yield of phospholipids is obtained.

The whey feed typically originates from rennet-based cheese whey, acid whey, casein whey, or a mixture thereof.

In some preferred embodiments of the present invention the whey lipid concentrate is prepared using steps a) and b) of the method according to International patent application no. PCT/EP2022/070107 (International publication no. WO2023001783A1) or steps a), b) and the microfiltration of step c) of the method according to International patent application no. PCT/EP2022/070107 but without the further processing described in relation to step c) of the method of PCT/EP2022/070107.

In some preferred embodiments of the present invention the whey lipid concentrate is therefore the filtration retentate obtained from step b) of the method according to International patent application no. PCT/EP2022/070107 or the microfiltration permeate obtained without further processing from step c) of the method according to International patent application no. PCT/EP2022/070107.

It is particularly preferred that the whey lipid concentrate is the microfiltration permeate obtained from step c) without further processing of the method according to International patent application no. PCT/EP2022/070107.

Particularly, preferred whey lipid concentrates are e.g. prepared according to steps a), b) of PCT/EP2022/070107 followed by the MF-based germ filtration of step c) of PCT/EP2022/070107. The embodiments and preferences presented in PCT/EP2022/070107 in relation to its step a), b) and the microfiltration of step c) equally apply to the preparation of the present whey lipid concentrate.

As mentioned above, the method of the present invention contains a step b) which involves subjecting the whey lipid concentrate to heat-treatment involving heating the whey lipid concentrate to a target temperature in the range of 63-160 °C with a holding time sufficient to provide at least some microbial reduction.

In some preferred embodiments of the present invention the heat-treatment of step b) involves direct heating. The inventors have found that direct heating often is advantageous as it allows for heating the whey lipid concentrate quickly and therefore limits the risk of destroying heat-sensitive nutrients while the whey lipid concentrate is heated to the target temperature of the step b).

By direct heating is meant heating systems wherein a heating medium such as steam is injected into the whey lipid concentrate, where the whey lipid concentrate is sprayed into a steam filled chamber, or where the heat is generated in the whey lipid concentrate, e.g. by ohmic heating or microwave-based heating.

In other preferred embodiments of the present invention the heat-treatment of step b) involves indirect heating. The inventors have found that indirect heating may be used instead of or in addition to the direct heating. Indirect heating is particularly preferred for the early heat-treatment of step b) or in embodiments relating to the high carbohydrate variant of the invention.

In some preferred embodiments of the present invention the heat-treatment of step b) involves indirect heating followed by direct heating.

Preferably, the indirect heating involves one of more of heating via a plate heat exchanger, a tubular heat exchanger, and a scraped-surface heat exchanger.

Preferably, the direct heating involve one of more of heating via steam infusion, direct steam injection, ohmic heating, and microwave heating. The use of steam infusion as the direct heating is particularly preferred.

In some preferred embodiments of the present invention heating performed when the whey lipid concentrate has a temperature above 63 °C is performed by direct heating.

In other preferred embodiments of the present invention any heating performed when the whey lipid concentrate has a temperature above 62 °C is performed by direct heating.

In further preferred embodiments of the present invention any heating performed when the whey lipid concentrate has a temperature above 60 °C is performed by direct heating.

It is often preferred that the heat-treatment of step b) comprises or even consists of heating by steam infusion.

In some preferred embodiments of the present invention the heat-treatment of step b) comprises heating the whey lipid concentrate by indirect heating and subsequently further heating the whey lipid concentrate by direct heating.

As mentioned above, indirect heating and direct heat-treatment can advantageously be combined. In some preferred embodiments of the present invention the heat-treatment of step b) comprises heating the whey lipid concentrate to a temperature of at least 50 °C by indirect heating and subsequently further heating the whey lipid concentrate to at least 65 degrees C by direct heating.

For example, in some preferred embodiments of the present invention the heat-treatment of step b) comprises heating the whey lipid concentrate to a temperature of at least 50 °C by indirect heating and subsequently further heating the whey lipid concentrate to the target temperature by direct heating, preferably involving steam infusion or steam injection.

The holding time of the heat-treatment of step b) is selected to provide the desired level of microbial reduction.

In the context of the present invention the term “holding time” pertains to time during which the whey lipid concentrate has a temperature which is at or slightly above the target temperature. In practical terms the target temperature is typically set as the lowest permissible temperature during the holding time and the whey lipid concentrate may be heated to slightly higher temperatures, may be upto 1.5 °C higher than the target temperature to have sufficient safety margin for temperature fluctuations. However, the temperature of the whey lipid concentrate during the holding time must not exceed the upper limit of the temperature range within which the target temperature has been selected.

The holding time is typically preceded by a temperature ramp-up phase and a followed by a cooling phase.

The duration of the temperature ramp-up phase of step b) is defined as the duration during the ramp-up during which the whey lipid concentrate has a temperature of at least 60 °C and less than the target temperature.

The duration of the cooling phase of step b) is defined as the duration during the cooling during which the whey lipid concentrate has a temperature lower than the target temperature but at least 60 °C.

It is often preferred that the temperature ramp-up phase and the cooling phase are designed to cause minimum thermal damage to the heat-sensitive components of the whey lipid concentrate.

Preferably, at least 50% of the denaturation of native lactoferrin that during step b) occurs at the target temperature, more preferably at least 60%, even more preferably at least 70%, and most preferably at least 80% of the denaturation of native lactoferrin during step b).

The duration of the temperature ramp-up phase of step b) is preferably at most 20 seconds, more preferably at most 10 seconds, even more preferably at most 8 seconds, and most preferably at most 4 seconds.

In some preferred embodiments of the present invention the duration of the temperature ramp-up phase of step b) is at most 2 second, more preferably at most 1 second, and most preferably at most 0.5 seconds.

The direct heating methods, and particularly steam infusion and steam injection are well suited for rapid heating of the whey lipid concentrate.

The duration of the cooling phase of step b) is preferably at most 20 seconds, more preferably at most 10 seconds, even more preferably at most 8 seconds, and most preferably at most 4 seconds.

In some preferred embodiments of the present invention the duration of the cooling phase of step b) is at most 2 second, more preferably at most 1 second, and most preferably at most 0.5 seconds.

Cooling by flash-cooling is well suited for rapid cooling after the whey lipid concentrate has been held sufficient time at the target temperature.

It is often preferred that the duration of the heat-treatment of step b) is selected so that the heat-treatment of step b) is capable of reducing the total plate count of a whey lipid concentrate by at least 99.9%. Even more preferred the duration of the heat-treatment of step b) is selected so that the heat-treatment of step b) is capable of reducing the total plate count of a whey lipid concentrate by at least 99.99%.

In some preferred embodiments of the present invention the duration of the heat-treatment of step b) is selected so that the heat-treatment of step b) is capable of reducing the total plate count of a whey lipid concentrate by 99.9%-99.9999%, and most preferably by 99.99%-99.999%.

In other preferred embodiments of the present invention the duration of the heat-treatment of step b) is selected so that the heat-treatment of step b) is capable of reducing the total plate count of a whey lipid concentrate by 99.9%-99.999999%, and most preferably by 99.999%-99.999999%

Is it particularly preferred that the duration of the heat-treatment of step b) is selected so that the heat-treatment of step b) is capable of reducing the total plate count of a whey lipid concentrate by approximately 99.999%.

In some preferred embodiments of the present invention the target temperature and a duration of the heat-treatment of step b) is sufficient to denature at most 80% w/w of the native beta-lactoglobulin of the whey lipid concentrate, more preferably at most 60% of the native beta-lactoglobulin of the whey lipid concentrate, even more preferably at most 50% w/w of the native beta-lactoglobulin of the whey lipid concentrate, and most preferably at most 45% w/w of the native beta-lactoglobulin of the whey lipid concentrate.

In other preferred embodiments of the present invention the target temperature and a heating duration of the heat-treatment of step b) is sufficient to denature at most 40% w/w of the native beta-lactoglobulin of the whey lipid concentrate, more preferably at most 30% of the native beta-lactoglobulin of the whey lipid concentrate, even more preferably at most 20% w/w of the native beta-lactoglobulin of the whey lipid concentrate, and most preferably at most 10% w/w of the native beta-lactoglobulin of the whey lipid concentrate.

In some preferred embodiments of the present invention the heat-treatment of step b) denatures at most 80% w/w of the native beta-lactoglobulin of the whey lipid concentrate, more preferably at most 60% of the native beta-lactoglobulin of the whey lipid concentrate, even more preferably at most 50% w/w of the native beta-lactoglobulin of the whey lipid concentrate, and most preferably at most 45% w/w of the native beta-lactoglobulin of the whey lipid concentrate.

In other preferred embodiments of the present invention the heat-treatment of step b) denatures at most 40% w/w of the native beta-lactoglobulin of the whey lipid concentrate, more preferably at most 30% of the native beta-lactoglobulin of the whey lipid concentrate, even more preferably at most 20% w/w of the native beta-lactoglobulin of the whey lipid concentrate, and most preferably at most 10% w/w of the native beta-lactoglobulin of the whey lipid concentrate.

In some preferred embodiments of the present invention the heat-treatment of step b) heats the whey lipid concentrate to a target temperature in the range of 70-75 °C with a holding time in the range of 1-60 seconds.

In other preferred embodiments of the present invention the heat-treatment of step b) heats the whey lipid concentrate to a target temperature in the range of 71-74 °C with a holding time in the range of 5-30 seconds.

Higher temperatures can also be used and in some preferred embodiments of the present invention the heat-treatment of step b) heats the whey lipid concentrate to a target temperature in the range of 85-95 °C with a holding time in the range of 0.05-10 seconds, and more preferably 88-92 °C with a holding time in the range of 0.2-2 seconds.

Even higher temperatures may be used and in some preferred embodiments of the present invention the heat-treatment of step b) heats the whey lipid concentrate to a target temperature in the range of 92-98 °C with a holding time in the range of 0.01-1 seconds, and more preferably 93-97 °C with a holding time in the range of 0.02-0.5 seconds.

Even higher temperatures may be used and in some preferred embodiments of the present invention the heat-treatment of step b) heats the whey lipid concentrate to a target temperature in the range of 97-103 °C with a holding time in the range of 0.001-0.06 seconds, and more preferably 98-102 °C with a holding time in the range of 0.005-0.04 seconds.

The inventors have found that heat-treatment by direct heating is preferred when using target temperatures of 70 °C or higher, and even more preferred when using target temperatures of 80 °C or higher.

It is often preferred that the heat-treatment of step b) employs combination of target temperature and holding time which is capable of providing a level of reduction of Coxiella burnetii in the whey lipid concentrate which is at least equivalent to heat-treatment to a target temperature of 72 °C with a holding time of 15 seconds.

In other preferred embodiments of the invention the heat-treatment of step b) employs a combination of target temperature and holding time which is capable of providing a level of reduction of Coxiella burnetii in the whey lipid concentrate which is equivalent to heat-treatment to a target temperature of 72-74 °C with a holding time of 15 seconds.

For example it may be preferred that preferred embodiments of the present invention the heat-treatment of step b) employs a target temperature in the range of 100-180 °C, more preferably 120-170 °C, and most preferably 140-160 °C, and a holding time which is capable of providing a level of reduction of Coxiella burnetii in the whey lipid concentrate which is equivalent to heat-treatment to a target temperature of 72-74 °C with a holding time of 15 seconds.

Unless the heat-treated whey lipid concentrate is dried directly after the heat-treatment of step b) without any prior cooling, the whey lipid concentrate is typically subjected to a cooling step as the last part of step c).

Thus, in some preferred embodiments of the present invention step b) furthermore involves cooling the heat-treated whey lipid concentrate, preferably to a temperature of less than 60 °C.

Typically, the cooling during step b) involves indirect cooling, e.g. using a plate heat exchanger or a tubular heat exchanger, and/or flash cooling.

In some preferred embodiments of the present invention the heat-treated whey lipid concentrate obtained from step b) is sent directly to the drying of step c).

It may even be preferred that the heat-treated whey lipid concentrate is not subjected to a cooling step prior to the drying of step c).

As mentioned above, step c) involves drying a liquid composition comprising at least lipid and protein of the heat-treated whey lipid concentrate obtained from step b).

The terms “liquid composition comprising at least lipid and protein of the heat-treated whey lipid concentrate obtained from step b)” and “liquid composition that is dried” are used inter-changeably.

While any drying-method may be used it is often preferred to a drying method that minimized the risk of further protein denaturation.

In some preferred embodiments of the present invention the drying of step c) involves spray-drying.

In other preferred embodiments of the present invention the drying of step c) involves freeze-drying.

In some preferred embodiments of the present invention the heat-treated whey lipid concentrate obtained from step b) makes up at least 70% w/w of the liquid composition to be dried, more preferably at least 80% w/w, even more preferably 90% w/w of the liquid composition that is dried in step c).

It is often preferred that the liquid composition that is dried in step c) is the heat-treated whey lipid concentrate obtained from step b).

In further preferred embodiments of the present invention the solids of the heat-treated whey lipid concentrate obtained from step b) makes up at least 70% w/w of the solids of the liquid composition that is dried in step c), more preferably at least 80% w/w, even more preferably 90% w/w of the solids of the liquid composition that is dried in step c).

It is often preferred that the solids of the liquid composition that is dried in step c) are the sol-ids of the heat-treated whey lipid concentrate obtained from step b).

In other preferred embodiments of the present invention the lipid and protein of the heat-treated whey lipid concentrate obtained from step b) makes up at least 70% w/w of the lipid and protein of the liquid composition that is dried in step c), more preferably at least 80% w/W, even more preferably 90% w/w of the liquid composition that is dried in step c).

It is often preferred that the lipid and protein of the liquid composition that is dried in step c) is the lipid and protein of the heat-treated whey lipid concentrate obtained from step b).

In some preferred embodiments of the present invention liquid composition that is dried in step c) is a protein concentrate of the heat-treated whey lipid concentrate obtained from step b), preferably obtained by evaporation and/or concentration by reverse osmosis of the heat-treated whey lipid concentrate obtained from step b).

It is often preferred that the liquid composition that is dried in step c) is obtained by evaporation of the heat-treated whey lipid concentrate obtained from step b).

The inventors have found that concentration by reverse osmosis gives rise to less protein denaturation than concentration by evaporation. If concentration is required, it is therefore preferable to concentrate the heat-treated whey lipid concentrate obtained from step b) by reverse osmosis if the level of protein denaturation should be kept as low as possible.

The heat-treated whey lipid concentrate obtained from step b) has a very low content of micro-organisms, and may in some embodiments even be sterile. It is therefore preferred that the further handling of the heat-treated whey lipid concentrate obtained from step b) is performed without increasing the content of microorganisms. In some preferred embodiments of the present invention the further handling of the heat-treated whey lipid concentrate obtained from step b) is performed under aseptic conditions.

In some preferred embodiments of the present invention step c) is performed under aseptic conditions, meaning that no microorganisms are added to the liquid composition that is dried during step c).

Likewise it is often preferred that any processing of the heat-treated whey lipid concentrate obtained from step b) is conducted aseptically to avoid adding microorganisms during processing.

The method often contains a further step of packaging the whey-derived powder obtained from step c). The packaging involves filling the whey-derived powder obtained from step c) in suitable containers, and subsequently sealing the containers.

In some embodiments of the invention the whey-derived powder is hermetically sealed in the container, and optionally packaged with an inert gas.

A wide range of different containers may be used for the whey-derived powder. Preferred containers are e.g. a bag, a barrel, a pouch, a box, a can, and a sachet. Bags are particularly preferred.

The packaging step is preferably performed under aseptic conditions to avoid adding further microorganisms to the whey-derived powder during the packaging step.

It is preferred that the present method does not involve solvent extraction or fluid extraction, such as e.g. supercritical or near critical fluid extraction.

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
a content of phospholipid of 1.5-12% w/w relative to total solids,
   a weight ratio between phospholipid and total protein of at least 0.04,
   a content of carbohydrate of 25-70% w/w relative to TS, comprising lactose in an amount of at least 50% w/w relative to carbohydrate,
   a total solids content of 5-20% w/w, most preferably 10-18% w/w,
   a content of native immunoglobulin G of 1-17% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction, wherein the heat-treatment of step b) denatures at most 50% w/w of the native beta-lactoglobulin of the whey lipid concentrate, more preferably at most 40% of the native beta-lactoglobulin of the whey lipid concentrate,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of 25-70% w/w relative to TS, comprising lactose in an amount of at least 50% w/w relative to carbohydrate,
   a total solids content of 5-20% w/w, most preferably 10-18% w/w,
   a content of native immunoglobulin G of 1-17% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 70-75 °C with a holding time of 1-60 seconds,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of at most 70% w/w relative to TS, comprising lactose in an amount of at least 50% w/w relative to carbohydrate,
   a total solids content of 5-20% w/w, most preferably 10-18% w/w,
   a content of native immunoglobulin G of 1-17% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction, wherein heating performed when the whey lipid concentrate has a temperature above 63 °C is performed by direct heating, preferably by steam infusion, and wherein the heat-treatment of step b) denatures at most 50% w/w of the native beta-lactoglobulin of the whey lipid concentrate, more preferably at most 40% of the native beta-lactoglobulin of the whey lipid concentrate,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of at most 70% w/w relative to TS, comprising lactose in an amount of at least 50% w/w relative to carbohydrate,
   a total solids content of 5-20% w/w, most preferably 10-18% w/w,
   a content of native immunoglobulin G of 1-17% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 70-75 °C with a holding time of 1-60 seconds, wherein heating performed when the whey lipid concentrate has a temperature above 63 °C is performed by direct heating, preferably by steam infusion, and
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of 25-70% w/w relative to TS, comprising lactose in an amount of at least 50% w/w relative to carbohydrate,
   a total solids content of 5-20% w/w, most preferably 10-18% w/w,
   a content of native immunoglobulin G of 1-17% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 70-75 °C with a holding time of 1-60 seconds, wherein heating performed when the whey lipid concentrate has a temperature above 63 °C is performed by direct heating, preferably by steam infusion, and
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of 25-70% w/w relative to TS, comprising lactose in an amount of at least 50% w/w relative to carbohydrate,
   a content of Fe(II) in an amount of 3-30 mg per kg protein, and even more preferably 4-15 mg per kg protein,
   a total solids content of 5-20% w/w, most preferably 10-18% w/w,
   a content of native immunoglobulin G of 1-17% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction, wherein the heat-treatment of step b) denatures at most 50% w/w of the native beta-lactoglobulin of the whey lipid concentrate, more preferably at most 40% of the native beta-lactoglobulin of the whey lipid concentrate,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of 25-70% w/w relative to TS, comprising lactose in an amount of at least 50% w/w relative to carbohydrate,
   a content of Fe(II) in an amount of 3-30 mg per kg protein, and even more preferably 4-15 mg per kg protein,
   a total solids content of 5-20% w/w, most preferably 10-18% w/w,
   a content of native immunoglobulin G of 1-17% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 70-75 °C with a holding time of 1-60 seconds,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of at most 70% w/w relative to TS, comprising lactose in an amount of at least 50% w/w relative to carbohydrate,
   a content of Fe(II) in an amount of 3-30 mg per kg protein, and even more preferably 4-15 mg per kg protein,
   a total solids content of 5-20% w/w, most preferably 10-18% w/w,
   a content of native immunoglobulin G of 1-17% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction, wherein heating performed when the whey lipid concentrate has a temperature above 63 °C is performed by direct heating, preferably by steam infusion, and wherein the heat-treatment of step b) denatures at most 50% w/w of the native beta-lactoglobulin of the whey lipid concentrate, more preferably at most 40% of the native beta-lactoglobulin of the whey lipid concentrate,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of at most 70% w/w relative to TS, comprising lactose in an amount of at least 50% w/w relative to carbohydrate,
   a content of Fe(II) in an amount of 3-30 mg per kg protein, and even more preferably 4-15 mg per kg protein,
   a total solids content of 5-20% w/w, most preferably 10-18% w/w,
   a content of native immunoglobulin G of 1-17% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 70-75 °C with a holding time of 1-60 seconds, wherein heating performed when the whey lipid concentrate has a temperature above 63 °C is performed by direct heating, preferably by steam infusion, and
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of 25-70% w/w relative to TS, comprising lactose in an amount of at least 50% w/w relative to carbohydrate,
   a total solids content of 5-20% w/w, most preferably 10-18% w/w,
   a content of native immunoglobulin G of 7-16% w/w relative to total protein, and most preferably 10-15% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction, wherein the heat-treatment of step b) denatures at most 50% w/w of the native beta-lactoglobulin of the whey lipid concentrate, more preferably at most 40% of the native beta-lactoglobulin of the whey lipid concentrate,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of 25-70% w/w relative to TS, comprising lactose in an amount of at least 50% w/w relative to carbohydrate,
   a total solids content of 5-20% w/w, most preferably 10-18% w/w,
   a content of native immunoglobulin G of 7-16% w/w relative to total protein, and most preferably 10-15% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 70-75 °C with a holding time of 1-60 seconds,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of at most 70% w/w relative to TS, comprising lactose in an amount of at least 50% w/w relative to carbohydrate,
   a total solids content of 5-20% w/w, most preferably 10-18% w/w,
   a content of native immunoglobulin G of 7-16% w/w relative to total protein, and most preferably 10-15% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction, wherein heating performed when the whey lipid concentrate has a temperature above 63 °C is performed by direct heating, preferably by steam infusion, and wherein the heat-treatment of step b) denatures at most 50% w/w of the native beta-lactoglobulin of the whey lipid concentrate, more preferably at most 40% of the native beta-lactoglobulin of the whey lipid concentrate,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of at most 70% w/w relative to TS, comprising lactose in an amount of at least 50% w/w relative to carbohydrate,
   a total solids content of 5-20% w/w, most preferably 10-18% w/w,
   a content of native immunoglobulin G of 7-16% w/w relative to total protein, and most preferably 10-15% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 70-75 °C with a holding time of 1-60 seconds, wherein heating performed when the whey lipid concentrate has a temperature above 63 °C is performed by direct heating, preferably by steam infusion, and
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of 25-70% w/w relative to TS, comprising lactose in an amount of at least 50% w/w relative to carbohydrate,
   a total solids content of 5-20% w/w, most preferably 10-18% w/w,
   a content of native immunoglobulin G of 7-16% w/w relative to total protein, and most preferably 10-15% w/w relative to total protein,
   a content of native lactoferrin of 0.1-1.5% w/w relative to total protein, and
b) subjecting the whey lipid concentrate to heat-treatment involving heating the whey lipid concentrate to a target temperature in the range of 70-75 °C with a holding time of 1-60 seconds, wherein heating performed when the whey lipid concentrate has a temperature above 63 °C is performed by direct heating, preferably by steam infusion, and
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of 25-70% w/w relative to TS, comprising lactose in an amount of at least 50% w/w relative to carbohydrate,
   a content of Fe(II) in an amount of 3-30 mg per kg protein, and even more preferably 4-15 mg per kg protein,
   a total solids content of 5-20% w/w, most preferably 10-18% w/w,
   a content of native immunoglobulin G of 7-16% w/w relative to total protein, and most preferably 10-15% w/w relative to total protein,
   a content of native lactoferrin of 0.3-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction, wherein the heat-treatment of step b) denatures at most 50% w/w of the native beta-lactoglobulin of the whey lipid concentrate, more preferably at most 40% of the native beta-lactoglobulin of the whey lipid concentrate,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of 25-70% w/w relative to TS, comprising lactose in an amount of at least 50% w/w relative to carbohydrate,
   a content of Fe(II) in an amount of 3-30 mg per kg protein, and even more preferably 4-15 mg per kg protein,
   a total solids content of 5-20% w/w, most preferably 10-18% w/w,
   a content of native immunoglobulin G of 7-16% w/w relative to total protein, and most preferably 10-15% w/w relative to total protein,
   a content of native lactoferrin of 0.3-1.5% w/w relative to total protein, and
b) subjecting the whey lipid concentrate to heat-treatment involving heating the whey lipid concentrate to a target temperature in the range of 70-75 °C with a holding time of 1-60 seconds,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of at most 70% w/w relative to TS, comprising lactose in an amount of at least 50% w/w relative to carbohydrate,
   a content of Fe(II) in an amount of 3-30 mg per kg protein, and even more preferably 4-15 mg per kg protein,
   a total solids content of 5-20% w/w, most preferably 10-18% w/w,
   a content of native immunoglobulin G of 7-16% w/w relative to total protein, and most preferably 10-15% w/w relative to total protein,
   a content of native lactoferrin of 0.3-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction, wherein heating performed when the whey lipid concentrate has a temperature above 63 °C is performed by direct heating, preferably by steam infusion, and wherein the heat-treatment of step b) denatures at most 50% w/w of the native beta-lactoglobulin of the whey lipid concentrate, more preferably at most 40% of the native beta-lactoglobulin of the whey lipid concentrate,
c) drying a liquid composition comprising at least lipid and protein of the heat-treated whey lipid concentrate obtained from step b).

In some particularly preferred embodiments of the present invention the method of preparing a whey-derived powder enriched with respect to whey lipid, which whey-derived powder is suitable for preparation of an infant formula powder by dry-blending, comprises the steps of:
a) providing a non-sterile whey lipid concentrate, preferably in which the whey lipid originates from a retentate obtained by membrane filtration of whey, the whey lipid concentrate having:
   a content of phospholipid of 1.5-12% w/w relative to total solids,
   a weight ratio between phospholipid and total protein of at least 0.04,
   a content of carbohydrate of at most 70% w/w relative to TS, comprising lactose in an amount of at least 50% w/w relative to carbohydrate,
   a content of Fe(II) in an amount of 3-30 mg per kg protein, and even more preferably 4-15 mg per kg protein,
   a total solids content of 5-20% w/w, most preferably 10-18% w/w,
   a content of native immunoglobulin G of 7-16% w/w relative to total protein, and most preferably 10-15% w/w relative to total protein,
   a content of native lactoferrin of 0.3-1.5% w/w relative to total protein, and
b) subjecting the whey lipid concentrate to heat-treatment involving heating the whey lipid concentrate to a target temperature in the range of 70-75 °C with a holding time of 1-60 seconds, wherein heating performed when the whey lipid concentrate has a temperature above 63 °C is performed by direct heating, preferably by steam infusion, and
c) drying a liquid composition comprising at least lipid and protein of the heat-treated whey lipid concentrate obtained from step b).

Another aspect of the invention pertains to a whey-derived powder obtainable according to the method described herein.

A further aspect of the invention pertains to a whey-derived powder (whey-derived powder) enriched with respect to whey lipid, the whey-derived powder having:
a content of phospholipid of at least 1.5% w/w relative to total solids,
a weight ratio between phospholipid and total protein of at least 0.04,
a content of lactose of at most 70% w/w relative to TS,
a total solids content of at least 92% w/W,
preferably, a content of native immunoglobulin G of 1-17% w/w relative to total protein,
preferably, a content of native lactoferrin of 0.1-1.5% w/w relative to total protein, said whey-derived powder having one or more of, and more preferably all of, the following characteristics:
a total plate count of at most 1000000 CFU/100 g of the whey-derived powder,
Cronobacter species are absent in at least 30 samples of 10 g of the whey-derived powder,
Salmonella species are absent in at least 30 samples of 25 g of the whey-derived powder, and
Enterobacteriaceae species are absent in at least 10 samples of 10 g of the whey-derived powder.

The terms “whey-derived powder” and “whey-derived powder enriched with respect to whey lipid” are used interchangeably herein.

In some preferred embodiments of the present invention the whey-derived powder comprises phospholipid in an amount of at least 1.5% w/w total solids, more preferably at least 3% w/w TS, even more preferably at least 5% w/w TS, and most preferably at least 6% w/w TS.

In other preferred embodiments of the present invention the whey-derived powder comprises phospholipid in an amount of at 4.0-12% w/w TS, more preferably 4.5-10% w/w TS, even more preferably 5.0-9% w/w TS, and most preferably 5.5-8.5% w/w TS. These range are particularly suitable in relation to the low carbohydrate variant of the invention.

In some preferred embodiments of the present invention the whey-derived powder comprises phospholipid in an amount of at 1.5-10% w/w TS, more preferably 1.6-8% w/w TS, even more preferably 1.8-6% w/w TS, and most preferably 3-5.5% w/w TS. These range are particularly suitable in relation to the high carbohydrate variant of the invention.

The content of total lipids of the whey-derived powder is typically exceeds the content of phospholipid. In some preferred embodiments of the present invention, the whey-derived powder comprises total lipid in an amount of at least 3% w/w TS, more preferably at least 6% w/w TS, even more preferably at least 10% w/w TS, and most preferably at least 16% w/w TS.

In other preferred embodiments of the present invention the whey-derived powder comprises lipid in an amount of at 8-30% w/w total solids, more preferably 10-26% w/w TS, even more preferably 12-24% w/w TS, and most preferably 15-22% w/w TS. These range are particularly suitable in relation to the low carbohydrate variant of the invention.

In further preferred embodiments of the present invention, the whey-derived powder comprises lipid in an amount of at 3.0-20% w/w total solids, more preferably 3.5-16% w/w TS, even more preferably 4-12% w/w TS, and most preferably 7-11% w/w TS. These range are particularly suitable in relation to the high carbohydrate variant of the invention.

The weight ratio between phospholipid and total lipid of the whey-derived powder is typically less than 1. In preferred embodiments of the present invention wherein the whey-derived powder has a weight ratio between phospholipid and total lipid of 0.20-0.50, more preferably 0.25-0.45, and most preferably 0.30-0.40.

The whey-derived powder preferably has a weight ratio between phospholipid and total protein of at least 0.04, more preferably at least 0.06, even more preferably at least 0.08, and most preferably at least 0.09.

In some preferred embodiments of the present invention the whey-derived powder has a weight ratio between phospholipid and total protein in the range of 0.04-0.25, more preferably 0.07-0.20, even more preferably 0.08-0.17, and most preferably 0.09-0.15.

The whey-derived powder typically contains protein and preferably comprises total protein in an amount of at least 20% w/w TS, and most preferably at least 25% w/w TS.

In some preferred embodiments of the present invention the whey-derived powder comprises total protein in an amount in the range of 20-80% w/w TS, and most preferably at least 25-75% w/w TS.

In other preferred embodiments of the present invention, the whey-derived powder comprises total protein in an amount of at least 60% w/w TS, and most preferably at least 65% w/w TS. Preferably, the whey-derived powder comprises total protein in an amount in the range of 60-80% w/w TS, more preferably 65-80% w/w TS, and most preferably 70-75% w/w TS.

Embodiments wherein the whey-derived powder comprises total protein in an amount of at least 60% w/w TS are particularly suitable in relation to the low carbohydrate variant of the invention.

In further preferred embodiments of the present invention the whey-derived powder comprises total protein in an amount less than 60% w/w TS, more preferably at most 55 w/w TS, and most preferably at most 50 w/w TS. Preferably, the whey-derived powder comprises total protein in an amount in the range of 20-60% w/w TS, more preferably 20-55% w/w TS, and most preferably 20-50% w/w TS. In other preferred embodiments of the present invention the whey-derived powder comprises total protein in an amount in the range of 22-50% w/w TS, more preferably 24-45% w/w TS, and most preferably 25-40% w/w TS.

Embodiments wherein the whey-derived powder comprises total protein in an amount less than 60% w/w TS are particularly suitable in relation to the high carbohydrate variant of the invention.

As mentioned above, the whey-derived powder typically comprises carbohydrate in an amount of 0-70% w/w TS.

Lactose is an important carbohydrate for e.g. infant nutrition and it is often preferred that lactose is present in the whey-derived powder in an amount of at least 50% w/w relative to the total amount of carbohydrate, more preferably at least 70% w/w, even more preferably at least 80% w/w, and most preferably at least 90% w/w relative to the total amount of carbohydrate. It may even be preferred that substantially all carbohydrate of the whey-derived powder is lactose, and it may therefore be preferred that lactose is present in the whey-derived powder in an amount of at least 93% w/w relative to the total amount of carbohydrate, more preferably at least 96% w/w, even more preferably at least 98% w/w, and most preferably at least 99% w/w relative to the total amount of carbohydrate.

Examples of other useful carbohydrates are maltodextrin, glucose, galactose, and combinations thereof. These may be used as such or in combination with lactose.

In some preferred embodiments of the present invention the whey-derived powder comprises lactose in an amount of 0-70% w/w TS.

In other preferred embodiments of the present invention, the whey-derived powder comprises carbohydrate in an amount of less than 25% w/w TS, more preferably at most 15% w/w TS, even more preferably at most 6% w/w TS, and most preferably at most 2% w/w TS.

For example, the whey-derived powder may comprises lactose in an amount of less than 25% w/w TS, more preferably at most 15% w/w TS, even more preferably at most 6% w/w TS, and most preferably at most 2% w/w TS.

In further preferred embodiments of the present invention, particularly useful for the high carbohydrate variant of the invention, the whey-derived powder comprises carbohydrate in an amount of 25-70% w/w TS, more preferably 35-70% w/w TS, and most preferably 40-70% w/w TS.

It is even more preferred that the whey-derived powder comprises carbohydrate in an amount of 45-70% w/w TS, more preferably 50-70% w/w TS, and most preferably 50-65% w/w TS.

In some preferred embodiments of the present invention the whey-derived powder comprises lactose in an amount of 25-70% w/w TS, more preferably 35-70% w/w TS, and most preferably 40-70% w/w TS.

In other preferred embodiments of the present invention, the whey-derived powder comprises lactose in an amount of 45-70% w/w TS, more preferably 50-70% w/w TS, and most preferably 50-65% w/w TS.

The inventors have seen indications that whey-derived powder of the invention have an improved usability, particularly in terms of wettability and dispersibility, when dry-blended powders containing the whey-derived powder are mixed with water or aqueous liquids, particularly in terms of wettability and dispersibility. This appears to be particularly pronounced in relation to the high carbohydrate variant of the invention.

In some preferred embodiments of the present invention, the whey-derived powder comprises lactose in an amount of 2-24% w/w, more preferably 3-24% w/w, and most preferably 4-24% w/w.

In other preferred embodiments of the present invention the whey-derived powder comprises lactose in an amount of 5-24% w/w, more preferably 5-20% w/w, and most preferably 8-18% w/w.

In some preferred embodiments of the present invention the whey-derived powder comprises carbohydrate in an amount of 3-24% w/w, more preferably 3-24% w/w, and most preferably 4-24 w/w.

The whey-derived powder may preferably comprises carbohydrate in an amount of 5-25% w/w, more preferably 5-20% w/w, and most preferably 8-18% w/w.

In other preferred embodiments of the present invention the whey-derived powder comprises carbohydrate in an amount of at most 2% w/w, more preferably at most 1% w/w, even more preferably at most 0.5% w/w, and most preferably at most 0.1% w/w.

For example, the whey-derived powder may comprise lactose in an amount of at most 2% w/w, more preferably at most 1% w/w, even more preferably at most 0.5% w/w, and most preferably at most 0.1% w/w.

The whey-derived powder typically has significantly lower microbial content than the whey lipid concentrate.

The whey-derived powder preferably has a total plate count of at most 1000000 colony forming units (CFU) per 100 g powder, more preferably at most 500000 CFU/100 g powder, and most preferably at most 100000 CFU/100 g powder.

Even lower total plate counts are often preferred and in some preferred embodiments of the present invention the whey-derived powder has a total plate count of at most 50000 colony forming units (CFU) per 100 g powder, more preferably at most 10000 CFU/100 g powder, even more preferably at most 3000 CFU/100 g powder, and most preferably at most 500 CFU/100 g powder.

In some preferred embodiments of the present invention the whey-derived powder furthermore has the following characteristics:
is free from Cronobacter species,
is free from Salmonella species, and
is free from Enterobacteriaceae.

In other preferred embodiments of the present invention the whey-derived powder is sterile.

The whey-derived powder preferably comprises total solids in an amount of 92-99% w/w, more preferably 93-98%, and most preferably 94-98% w/w.

The preferably has a considerable content of bioactive components such as e.g. immunoglobulins and lactoferrin.

In some preferred embodiments of the present invention the whey-derived powder has a content of native immunoglobulin G of 5-17% w/w relative to total protein, more preferably 7-16% w/w, even more preferably 8-15% w/w, and most preferably 10-15% w/w relative to total protein. The inventors have found that the high carbohydrate-variant of the invention and/or the use of direct heating in the heat-treatment of step b) favours the high contents of native immunoglobulin G.

In other preferred embodiments of the present invention the whey-derived powder has a content of native immunoglobulin G of 3-7% w/w relative to total protein.

In further preferred embodiments of the present invention the whey-derived powder has a content of native immunoglobulin G of 7-17% w/w relative to total protein, more preferably 8-17% w/w, and most preferably 10-17% w/w relative to total protein.

It is often preferred that the weight ratio between native immunoglobulin G and total immunoglobulin G of the whey-derived powder is at least 0.3, more preferably at least 0.5, even more preferably at least 0.6, and most preferably at least 0.8.

In some preferred embodiments of the present invention, the whey-derived powder has a content of native lactoferrin of 0.1-1.2% w/w relative to total protein, more preferably 0.2-1.2% w/w, even more preferably 0.3-1.2% w/w, and most preferably 0.3-1.1% w/w relative to total protein. The inventors have found that the high carbohydrate-variant of the invention and/or the use of direct heating in the heat-treatment of step b) favours relatively high contents of native lactoferrin.

In other preferred embodiments of the present invention, the whey-derived powder has a content of native lactoferrin of 0.1-0.3% w/w relative to total protein.

In other preferred embodiments of the present invention, the whey-derived powder has a content of native lactoferrin of 0.2-1.5% w/w relative to total protein, more preferably 0.3-1.5% w/w, even more preferably 0.4-1.5% w/w, and most preferably 0.5-1.5% w/w relative to total protein. These embodiments are e.g. feasible when the whey lipid concentrate has been prepared from whey that has only subjected to very low heat-treatments and/or when the whey lipid concentrate has been supplemented with Fe(II) prior to the heat-treatment.

It is normally preferred that the weight ratio between native lactoferrin and total lactoferrin of the whey-derived powder is at least 0.1, more preferably at least 0.2, even more preferably at least 0.3, and most preferably at least 0.4.

Alternatively, but also preferred, the weight ratio between native lactoferrin and total lactoferrin of the whey-derived powder may be in the range of 0.1-0.3.

In some embodiments of the invention, the whey-derived powder comprises at most 10% w/w casein relative to the total amount of protein, preferably at most 5% w/w, more preferably at most 1% w/w, and even more preferably at most 0.5% casein relative to the total amount of protein.

In some preferred embodiments of the present invention, the whey-derived composition comprises a total amount of beta-lactoglobulin in the range of 10-45% w/w relative to total protein, more preferably 15-40% w/w, even more preferably 20-40% w/w, and most preferably 25-35% w/w relative to total protein.

In some preferred embodiments of the present invention, the whey-derived composition comprises a total amount of alpha-lactalbumin in the range of 0-15% w/w relative to total protein, more preferably 0.1-10% w/w, even more preferably 0.3-9% w/w, and most preferably 0.5-7% w/w relative to total protein.

Alternatively but also preferred, the whey-derived composition comprises a total amount of alpha-lactalbumin in the range of 1-10% w/w relative to total protein, more preferably 1-9% w/w, even more preferably 2-8% w/w, and most preferably 3-7% w/w relative to total protein.

In some preferred embodiments of the present invention the whey-derived composition comprises a total amount of caseinomacropeptide in the range of 0-10% w/w relative to total protein, more preferably 1-8% w/w, even more preferably 2-7% w/w, and most preferably 3-7% w/w relative to total protein.

Alternatively, but also preferred, the whey-derived composition comprises a total amount of caseinomacropeptide in the range of 0-9% w/w relative to total protein, more preferably 0.1-7% w/w, even more preferably 0.3-5% w/w, and most preferably 0.5-3% w/w relative to total protein.

In further preferred embodiments of the present invention, typically if the whey-derived powder is based on casein whey and/or has been prepared using extensive diafiltration, the whey-derived powder comprises a total amount of caseinomacropeptide in the range of 0-5% w/w relative to total protein, more preferably 0-3% w/w, even more preferably 0-1% w/w, and most preferably 0-0.5% w/w relative to total protein.

In some preferred embodiments of the present invention the whey-derived composition comprises a total amount of osteopontin in the range of 0.9-5% w/w relative to total protein, more preferably 1.0-4% w/w, even more preferably 1.1-3% w/w, and most preferably 1.1-1.7% w/w relative to total protein.

In other preferred embodiments of the present invention, the whey-derived composition comprises a total amount of osteopontin in the range of 2.0-5% w/w relative to total protein, more preferably 2.2-4.5% w/w, even more preferably 2.5-4.0% w/w, and most preferably 3.0-3.7% w/w relative to total protein.

The inventors have found that it is often preferred that the whey-derived powder has a considerably content of total sialic acid and gangliosides.

In some preferred embodiments of the present invention the whey-derived powder has a content of total sialic acid in an amount of 1.7-3.5 g per 100 g protein, more preferably 2.0-3.3 g per 100 g protein and most preferred 2.4-2.9 g per 100 g protein.

In some preferred embodiments of the present invention the whey-derived powder has a content of ganglioside in an amount of 2500-5000 mg/kg protein, and most preferred 3500-4500 mg/kg protein.

In some preferred embodiments of the present invention the whey-derived powder has an ash content of 0.3-6% w/w relative to total solids, more preferably 0.5-5% w/w, even more preferably 1.0-4% w/w, and most preferably 1.2-3.5% w/w relative to total solids.

In other preferred embodiments of the present invention the whey-derived powder has an ash content of 0.3-2% w/w relative to total solids, more preferably 0.4-1.5% w/w, and most preferably 0.5-1.0% w/w relative to total solids.

The inventors have furthermore found that whey-derived powder containing Fe(II) in specific amounts tend to have a higher level of native lactoferrin.

In some preferred embodiments of the present invention the whey-derived powder has a content of Fe(II) in an amount of 2-50 mg per kg protein, more preferably 3-30 mg per kg protein, even more preferably 4-15 mg per kg protein, and most preferably 5-10 mg per kg protein.

A broad range of pH values may be employed. However, preferably, the whey-derived powder has pH of 4.0-8, more preferably 5.5-7.5, even more preferably 5.7-7.0, and most preferably 5.9-6.6.

In some preferred embodiments of the present invention the whey-derived powder is present in a quantity of at least 10 kg, more preferably at least 20 kg, even more preferably at least 30 kg, and most preferably at least 50 kg.

In some preferred embodiments of the present invention the whey-derived powder of the present invention is obtainable by the method of the present invention.

Yet an aspect of the invention pertains to a plurality of sealed containers, preferably in the form of sacks or bags, each container holding the whey-derived powder as described herein in an amount in the range of 10-1000 kg/container.

In some preferred embodiments of the present invention the plurality of sealed containers comprise at least 5 sealed containers.

Various container types may be used to hold the whey-derived powder. However, in some preferred embodiments of the present invention the container is a bag, a big bag, a barrel, a pouch, a box, a can, or a sachet. It is particularly preferred that the container is a bag or a big bag.

Bags typically contains 10-50 kg whey-derived powder, and most preferably 12-30 kg whey-derived powder.

Big bags typically contains 100-1000 kg whey-derived powder, and most preferably 300-800 kg whey-derived powder.

The containers, and preferably the bags or big bags, are preferably made of material that has a low water permeability.

In some particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of at most 70% w/w relative to TS, preferably wherein lactose comprises at least 50% w/w of the carbohydrate,
a total solids content of at least 92% w/w,
a content of native immunoglobulin G of 5-17% w/w relative to total protein, most preferably 10-15% w/w relative to total protein,
a content of native lactoferrin of 0.1-1.5% w/w relative to total protein, most preferably 0.1-1.2% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in at least 30 samples of 10 g of the whey-derived powder,
Salmonella species are absent in at least 30 samples of 25 g of the whey-derived powder, and
Enterobacteriaceae species are absent in at least 10 samples of 10 g of the whey-derived powder.

In other particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of at most 70% w/w relative to TS, preferably wherein lactose comprises at least 50% w/w of the carbohydrate,
a total solids content of at least 92% w/w,
a content of native immunoglobulin G of 5-17% w/w relative to total protein, most preferably 10-15% w/w relative to total protein,
a content of native lactoferrin of 0.1-1.5% w/w relative to total protein, most preferably 0.1-1.2% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in the whey-derived powder,
Salmonella species are absent in the whey-derived powder, and
Enterobacteriaceae species are absent in the whey-derived powder.

In some particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of 25-70% w/w relative to TS, preferably wherein lactose comprises at least 50% w/w of the carbohydrate,
a total solids content of at least 92% w/w,
a content of native immunoglobulin G of 5-17% w/w relative to total protein, most preferably 10-15% w/w relative to total protein,
a content of native lactoferrin of 0.1-1.5% w/w relative to total protein, most preferably 0.1-1.2% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in at least 30 samples of 10 g of the whey-derived powder,
Salmonella species are absent in at least 30 samples of 25 g of the whey-derived powder, and
Enterobacteriaceae species are absent in at least 10 samples of 10 g of the whey-derived powder.

In other particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of at 25-70% w/w relative to TS, preferably wherein lactose comprises at least 50% w/w of the carbohydrate,
a total solids content of at least 92% w/w,
a content of native immunoglobulin G of 5-17% w/w relative to total protein, most preferably 10-15% w/w relative to total protein,
a content of native lactoferrin of 0.1-1.5% w/w relative to total protein, most preferably 0.1-1.2% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in the whey-derived powder,
Salmonella species are absent in the whey-derived powder, and
Enterobacteriaceae species are absent in the whey-derived powder.

In some particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of 25-70% w/w relative to TS, preferably wherein lactose comprises at least 50% w/w of the carbohydrate,
a content of Fe(II) in an amount of 3-30 mg per kg protein, even more preferably 4-15 mg per kg protein,
a total solids content of at least 92% w/w,
a content of native immunoglobulin G of 5-17% w/w relative to total protein, most preferably 10-15% w/w relative to total protein,
a content of native lactoferrin of 0.3-1.5% w/w relative to total protein, most preferably 0.5-1.5% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in at least 30 samples of 10 g of the whey-derived powder,
Salmonella species are absent in at least 30 samples of 25 g of the whey-derived powder, and
Enterobacteriaceae species are absent in at least 10 samples of 10 g of the whey-derived powder.

In other particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of at 25-70% w/w relative to TS, preferably wherein lactose comprises at least 50% w/w of the carbohydrate,
a total solids content of at least 92% w/w,
a content of Fe(II) in an amount of 3-30 mg per kg protein, even more preferably 4-15 mg per kg protein,
a content of native immunoglobulin G of 5-17% w/w relative to total protein, most preferably 10-15% w/w relative to total protein,
a content of native lactoferrin of 0.3-1.5% w/w relative to total protein, most preferably 0.5-1.5% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in the whey-derived powder,
Salmonella species are absent in the whey-derived powder, and
Enterobacteriaceae species are absent in the whey-derived powder.

In some particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of at most 70% w/w relative to TS, preferably wherein lactose comprises at least 50% w/w of the carbohydrate,
a total solids content of at least 92% w/w,
a content of native immunoglobulin G of 7-16% w/w relative to total protein,
a content of native lactoferrin of 0.1-1.5% w/w relative to total protein, most preferably 0.1--1.2% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in at least 30 samples of 10 g of the whey-derived powder,
Salmonella species are absent in at least 30 samples of 25 g of the whey-derived powder, and
Enterobacteriaceae species are absent in at least 10 samples of 10 g of the whey-derived powder.

In other particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of at most 70% w/w relative to TS, preferably wherein lactose comprises at least 50% w/w of the carbohydrate,
a total solids content of at least 92% w/w,
a content of native immunoglobulin G of 7-16% w/w relative to total protein,
a content of native lactoferrin of 0.1-1.5% w/w relative to total protein, most preferably 0.1-1.2% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in the whey-derived powder,
Salmonella species are absent in the whey-derived powder, and
Enterobacteriaceae species are absent in the whey-derived powder.

In some particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of 25-70% w/w relative to TS, preferably wherein lactose comprises at least 50% w/w of the carbohydrate,
a total solids content of at least 92% w/w,
a content of native immunoglobulin G of 7-16% w/w relative to total protein,
a content of native lactoferrin of 0.1-1.5% w/w relative to total protein, most preferably 0.1-1.2% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in at least 30 samples of 10 g of the whey-derived powder,
Salmonella species are absent in at least 30 samples of 25 g of the whey-derived powder, and
Enterobacteriaceae species are absent in at least 10 samples of 10 g of the whey-derived powder.

In other particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of at 25-70% w/w relative to TS, preferably wherein lactose comprises at least 50% w/w of the carbohydrate,
a total solids content of at least 92% w/w,
a content of native immunoglobulin G of 7-16% w/w relative to total protein,
a content of native lactoferrin of 0.1-1.5% w/w relative to total protein, most preferably 0.1-1.2% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in the whey-derived powder,
Salmonella species are absent in the whey-derived powder, and
Enterobacteriaceae species are absent in the whey-derived powder.

In some particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of 25-70% w/w relative to TS, preferably wherein lactose comprises at least 50% w/w of the carbohydrate,
a content of Fe(II) in an amount of 3-30 mg per kg protein, even more preferably 4-15 mg per kg protein,
a total solids content of at least 92% w/w,
a content of native immunoglobulin G of 7-16% w/w relative to total protein,
a content of native lactoferrin of 0.3-1.5% w/w relative to total protein, most preferably 0.5-1.5% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in at least 30 samples of 10 g of the whey-derived powder,
Salmonella species are absent in at least 30 samples of 25 g of the whey-derived powder, and
Enterobacteriaceae species are absent in at least 10 samples of 10 g of the whey-derived powder.

In other particularly preferred embodiments of the present invention, the whey-derived powder enriched with respect to whey lipid has:
a content of phospholipid of 1.5-12% w/w relative to total solids,
a weight ratio between phospholipid and total protein of at least 0.04,
a content of carbohydrate of at 25-70% w/w relative to TS, preferably wherein lactose comprises at least 50% w/w of the carbohydrate,
a total solids content of at least 92% w/w,
a content of Fe(II) in an amount of 3-30 mg per kg protein, even more preferably 4-15 mg per kg protein,
a content of native immunoglobulin G 7-16% w/w relative to total protein,
a content of native lactoferrin of 0.3-1.5% w/w relative to total protein, most preferably 0.5-1.5% w/w relative to total protein, said whey-derived powder having the following characteristics:
a total plate count of at most 1000000 CFU/100 g of the whey-derived powder, most preferably at most 50000 CFU/100 g of the whey-derived powder,
Cronobacter species are absent in the whey-derived powder,
Salmonella species are absent in the whey-derived powder, and
Enterobacteriaceae species are absent in the whey-derived powder.

A further aspect of the invention pertains to use of the whey-derived powder as described herein as a food ingredient, for preparing a nutritional product, preferably for paediatric nutrition, and most preferably an infant formula product in powder form.

The nutritional product is preferably prepared by dry-blending the whey-derived powder with:
one or more additional powder ingredient(s), and
optionally, further powder ingredient comprising of probiotic bacteria.

It is often preferred that the nutritional product is a nutritional powder.

Term “one or more additional powder ingredient(s)” refer to ingredients that are not considered sources of probiotic bacteria. Useful examples of the one or more additional powder ingredient(s)” are e.g. lactose powder, maltodextrin powder, milk powder, whey powder, whey protein concentrate, infant formula base powder, cream powder, powder of vegetable oil, powder containing poly-unsaturated fatty acids, and powder of micronutrients.

The term “further powder ingredient comprising of probiotic bacteria” refers to sources of specific probiotic bacteria which often are used to enrich e.g. infant formula products or other nutritional products. Such further powder ingredient comprising of probiotic bacteria are often based on freeze-dried or otherwise conserved probiotic bacteria.

“Further powder ingredient(s) comprising of probiotic bacteria” preferably have a total plate count higher than 1000000 CFU/100 g ingredient powder due to the presence of the probiotic bacteria, but should have the further characteristics:
Cronobacter species are absent in at least 30 samples of 10 g ingredient powder,
Salmonella species are absent in at least 30 samples of 25 g ingredient powder, and
Enterobacteriaceae species are absent in at least 10 samples of 10 g ingredient powder.

More preferably the “further powder ingredient(s) comprising of probiotic bacteria” are:
are free from Cronobacter species,
are free from Samonella species, and
are free from Enterobacteriaceae.

The one or more additional powder ingredient(s) preferably have the following characteristics:
a total plate count of at most 1000000 CFU/100 g powder, more preferably of at most 500000 CFU/100 g ingredient powder, more preferably at most 100000 CFU/100 g ingredient powder, even more preferably 50000 CFU/100 g ingredient powder, and most preferably 10000 CFU/100 g ingredient powder,
Cronobacter species are absent in at least 30 samples of 10 g powder,
Salmonella species are absent in at least 30 samples of 25 g powder, and
Enterobacteriaceae species are absent in at least 10 samples of 10 g powder.

More preferably, the combination of the one or more additional powder ingredient(s) has the following characteristics:
has a total plate count of at most 500000 CFU/100 g ingredient powder, more preferably at most 100000 CFU/100 g ingredient powder, even more preferably 50000 CFU/100 g ingredient powder, and most preferably 10000 CFU/100 g ingredient powder,
are free from Cronobacter species,
are free from Samonella species, and
are free from Enterobacteriaceae.

In some preferred embodiments of the present invention each of the one or more additional ingredients have the following characteristics:
has a total plate count of at most 1000000 CFU/100 g powder, more preferably of at most 500000 CFU/100 g ingredient powder, more preferably at most 100000 CFU/100 g ingredient powder, even more preferably 50000 CFU/100 g ingredient powder, and most preferably 10000 CFU/100 g ingredient powder,
Cronobacter species are absent in at least 30 samples of 10 g powder,
Salmonella species are absent in at least 30 samples of 25 g powder, and
Enterobacteriaceae species are absent in at least 10 samples of 10 g powder.

More preferably, each of the one or more additional ingredients have the following characteristics:
has a total plate count of at most 50000 CFU/100 g powder,
are free from Cronobacter species,
are free from Samonella species, and
are free from Enterobacteriaceae.

Even more preferably, the combination of the one or more additional ingredient(s) has the following characteristics:
has a total plate count of at most 10000 CFU/100 g powder,
are free from Cronobacter species,
are free from Samonella species, and
are free from Enterobacteriaceae.

The whey-derived powder is preferably used in an amount sufficient to contribute with at least 25% w/w of the total amount of the phospholipid of the nutritional powder, more preferably at least 40% w/w, even more preferably at least 50% w/w, and more preferably at least 60% w/w of the total amount of the phospholipid of the nutritional powder.

An even further aspect of the invention pertains to a process of producing a nutritional powder, preferably for paediatric nutrition, and more preferably an infant formula, the process compressing dry-blending the whey-derived powder with:
one or more additional powder ingredient(s), and
optionally, a further powder ingredient comprising of probiotic bacteria, preferably, wherein the one or more additional powder ingredient(s) have the following characteristics:
a total plate count of at most 1000000 CFU/100 g ingredient powder,
Cronobacter species are absent in at least 30 samples of 10 g ingredient powder,
Salmonella species are absent in at least 30 samples of 25 g ingredient powder, and
Enterobacteriaceae species are absent in at least 10 samples of 10 g ingredient powder.

Preferably the one or more additional powder ingredient(s) have a total plate count of at most 500000 CFU/100 g ingredient powder, more preferably at most 100000 CFU/100 g ingredient powder, even more preferably 50000 CFU/100 g ingredient powder, and most preferably 10000 CFU/100 g ingredient powder.

It is often preferred that the one or more additional powder ingredient(s) are:
are free from Cronobacter species,
are free from Samonella species, and
are free from Enterobacteriaceae.

As mentioned above, the whey-derived powder is preferably used in an amount sufficient to contribute with at least 25% w/w of the total amount of the phospholipid of the nutritional powder, more preferably at least 40% w/w, even more preferably at least 50% w/w, and more preferably at least 60% w/w of the total amount of the phospholipid of the nutritional powder.

Another aspect pertains to a nutritional powder comprising a dry-blend of the whey-derived powder described herein, one or more additional powder ingredient(s), and optionally a further powder ingredient comprising of probiotic bacteria.

In the context of the present invention, the term “a dry-blend” pertains to the product obtained by dry-blending a set of powder ingredients.

The combination of the one or more additional ingredient(s), i.e. the combined one or more additional ingredient(s) in the quantities used for preparing the nutritional powder, preferably has the following characteristics:
has a total plate count of at most 1000000 CFU/100 g powder, more preferably of at most 500000 CFU/100 g ingredient powder, more preferably at most 100000 CFU/100 g ingredient powder, even more preferably 50000 CFU/100 g ingredient powder, and most preferably 10000 CFU/100 g ingredient powder,
Cronobacter species are absent in at least 30 samples of 10 g powder,
Salmonella species are absent in at least 30 samples of 25 g powder, and
Enterobacteriaceae species are absent in at least 10 samples of 10 g powder.

Preferably, the nutritional powder has been prepared by dry-blending of the whey-derived powder as described herein, the one or more additional powder ingredient(s), and optionally also a further powder ingredient comprising of probiotic bacteria.

It is often preferred that the nutritional powder is nutritionally complete, preferably in compliance with:
EU Regulation No 609/2013 which sets out criteria for Foods for Special Medical Purposes and/or
US Code of Federal Regulations, Title 21, CHAPTER I, SUBCHAPTER B, PART 107 (INFANT FORMULA), Sub-part D (Nutrient Requirements); Sec. 107.100 Nutrient specifications as in force on 1 Apr. 2015.

However, in some preferred embodiments of the present invention the nutritional powder is nutritionally incomplete meaning that it lacks one or more macronutrients and/or micronutrients to be nutritionally complete according to EU Regulation No 609/2013.

The nutritional powder may be used for various nutritional applications. However, in some preferred embodiments of the present invention the nutritional powder is in the form of a paediatric product such as e.g. an infant formula, a growing up formula, or a follow-on formula.

It is particularly preferred that the nutritional powder is an infant formula powder.

In the context of the present invention, the term “infant formula” pertains to nutritionally complete food products for infants of 0-6 months which food products preferably comply with the US Code of Federal Regulations, Title 21, CHAPTER I, SUBCHAPTER B, PART 107 (INFANT FORMULA), Sub-part D (Nutrient Requirements); Sec. 107.100 Nutrient specifications as in force on 1 Apr. 2015 or EU Regulation No 609/2013 which sets out criteria for Foods for Special Medical Purposes.

It is particularly referred that the nutritional powder is a nutritionally complete infant formula for infants of 0-6 months which complies with the US Code of Federal Regulations, Title 21, CHAPTER I, SUBCHAPTER B, PART 107 (INFANT FORMULA), Sub-part D (Nutrient Requirements); Sec. 107.100 Nutrient specifications as in force on 1 Apr. 2015.

The whey-derived powder is preferably used in an amount sufficient to contribute with at least 25% w/w of the total amount of the phospholipid of the nutritional powder, more preferably at least 40% w/w, even more preferably at least 50% w/w, and more preferably at least 60% w/w of the total amount of the phospholipid of the nutritional powder.

In some preferred embodiments of the present invention the nutritional powder is obtainable by the process of the present invention.

The following numbered embodiments are all preferred embodiments of the invention.

Numbered embodiment 1. A method of preparing a whey-derived powder enriched with respect to whey lipid, which whey-derived powder is suitable for preparation of an infant formula powder by dry-blending, the method comprising the steps of:
a) providing a non-sterile whey lipid concentrate, the whey lipid concentrate having:
   a content of phospholipid of at least 1.5% w/w relative to total solids,
   a weight ratio between phospholipid and total protein of at least 0.04,
   a content of carbohydrate of at most 70% w/w relative to TS,
   a total solids content of 1-50% w/w,
   preferably, a content of native immunoglobulin G of 1-17% w/w relative to total protein,
   preferably, a content of native lactoferrin of 0.1-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction,
c) drying a liquid composition comprising at least lipid and protein of the heat-treated whey lipid concentrate obtained from step b).

Numbered embodiment 2. The method according to numbered embodiment 1 wherein:
the whey lipid concentrate comprises lactose in an amount of 25-70% w/w TS, and/or
the heat-treatment of step b) involves heating by direct heating, preferably involving heating by steam infusion, and preferably wherein any heating performed when the whey lipid concentrate has a temperature above 63 °C is performed by direct heating, preferably by steam infusion.

Numbered embodiment 3. The method according to numbered embodiment 1 or 2 wherein the whey lipid concentrate comprises phospholipid in an amount of at least 1.5% w/w total solids, more preferably at least 3% w/w TS, even more preferably at least 5% w/w TS, and most preferably at least 6% w/w TS.

Numbered embodiment 4. The method according to any one of the preceding numbered embodiments wherein the whey lipid concentrate comprises phospholipid in an amount of at 4.0-12% w/w TS, more preferably 4.5-10% w/w TS, even more preferably 5.0-9% w/w TS, and most preferably 5.5-8.5% w/w TS.

Numbered embodiment 5. The method according to any one of the preceding numbered embodiments wherein the whey lipid concentrate comprises phospholipid in an amount of at 1.5-10% w/w TS, more preferably 1.6-8% w/w TS, even more preferably 1.8-6% w/w TS, and most preferably 3-3.5% w/w TS.

Numbered embodiment 6. The method according to any one of the preceding numbered embodiments wherein the whey lipid concentrate comprises total lipid in an amount of at least 3% w/w TS, more preferably at least 6% w/w TS, even more preferably at least 10% w/w TS, and most preferably at least 16% w/w TS.

Numbered embodiment 7. The method according to any one of the preceding numbered embodiments wherein the whey lipid concentrate comprises lipid in an amount of at 8-30% w/w total solids, more preferably 10-26% w/w TS, even more preferably 12-24% w/w TS, and most preferably 15-22% w/w TS.

Numbered embodiment 8. The method according to any one of the preceding numbered embodiments wherein the whey lipid concentrate comprises lipid in an amount of at 3.0-20% w/w total solids, more preferably 3.5-16% w/w TS, even more preferably 4-12% w/w TS, and most preferably 7-11% w/w TS.

Numbered embodiment 9. The method according to any one of the preceding numbered embodiments, wherein the whey lipid concentrate has a weight ratio between phospholipid and total lipid of 0.20-0.50, more preferably 0.25-0.45, and most preferably 0.30-0.40.

Numbered embodiment 10. The method according to any one of the preceding numbered embodiments, wherein the whey lipid concentrate has a weight ratio between phospholipid and total protein of at least 0.04, more preferably at least 0.06, even more preferably at least 0.08, and most preferably at least 0.09.

Numbered embodiment 11. The method according to any one of the preceding numbered embodiments, wherein the whey lipid concentrate has a weight ratio between phospholipid and total protein in the range of 0.04-0.25, more preferably 0.07-0.20, even more preferably 0.08-0.17, and most preferably 0.09-0.15.

Numbered embodiment 12. The method according to any one of the preceding numbered embodiments, wherein the whey lipid concentrate comprises total protein in an amount in the range of at least 20% w/w TS, and most preferably at least 25% w/w TS.

Numbered embodiment 13. The method according to any one of the preceding numbered embodiments, wherein the whey lipid concentrate comprises total protein in an amount in the range of 20-80% w/w TS, and most preferably 25-75% w/w TS.

Numbered embodiment 14. The method according to any one of the preceding numbered embodiments, wherein the whey lipid concentrate comprises total protein in an amount of at least 60% w/w TS, and most preferably at least 65% w/w TS.

Numbered embodiment 15. The method according to any one of the preceding numbered embodiments, wherein the whey lipid concentrate comprises total protein in an amount in the range of 60-80% w/w TS, more preferably 65-80% w/w TS, and most preferably 70-75% w/w TS.

Numbered embodiment 16. The method according to any one of the preceding numbered embodiments, wherein the whey lipid concentrate comprises total protein in an amount less than 60% w/w TS, more preferably at most 55 w/w TS, and most preferably at most 50 w/w TS.

Numbered embodiment 17. The method according to any one of the preceding numbered embodiments, wherein the whey lipid concentrate comprises total protein in an amount in the range of 20-60% w/w TS, more preferably 20-55% w/w TS, and most preferably 20-50% w/w TS.

Numbered embodiment 18. The method according to any one of the preceding numbered embodiments, wherein the whey lipid concentrate comprises total protein in an amount in the range of 22-50% w/w TS, more preferably 24-45% w/w TS, and most preferably 25-40% w/w TS.

Numbered embodiment 19. The method according to any one of the preceding numbered embodiments wherein the whey lipid concentrate comprises lactose in an amount of 0-70% w/w TS.

Numbered embodiment 20. The method according to any one of the preceding numbered embodiments wherein the whey lipid concentrate comprises lactose in an amount of less than 25% w/w TS, more preferably at most 15% w/w TS, even more preferably at most 6% w/w TS, and most preferably at most 2% w/w TS.

Numbered embodiment 21. The method according to any one of the preceding numbered embodiments wherein the whey lipid concentrate comprises carbohydrate in an amount of less than 25% w/w TS, more preferably at most 15% w/w TS, even more preferably at most 6% w/w TS, and most preferably at most 2% w/w TS.

Numbered embodiment 22. The method according to any one of the preceding numbered embodiments wherein the whey lipid concentrate comprises lactose in an amount of 25-70% w/w TS, more preferably 35-70% w/w TS, and most preferably 40-70% w/w TS.

Numbered embodiment 23. The method according to any one of the preceding numbered embodiments wherein the whey lipid concentrate comprises lactose in an amount of 45-70% w/w TS, more preferably 50-70% w/w TS, and most preferably 50-65% w/w TS.

Numbered embodiment 24. The method according to any one of the preceding numbered embodiments wherein the whey lipid concentrate comprises carbohydrate in an amount of 25-70% w/w TS, more preferably 35-70% w/w TS, and most preferably 40-70% w/w TS.

Numbered embodiment 25. The method according to any one of the preceding numbered embodiments wherein the whey lipid concentrate comprises carbohydrate in an amount of 45-70% w/w TS, more preferably 50-70% w/w TS, and most preferably 50-65% w/w TS.

Numbered embodiment 26. The method according to any one of the preceding numbered embodiments wherein the whey lipid concentrate comprises lactose in an amount of 2-24% w/w, more preferably 3-25% w/w, and most preferably 4-25% w/w.

Numbered embodiment 27. The method according to any one of the preceding numbered embodiments wherein the whey lipid concentrate comprises lactose in an amount of 5-25% w/w, more preferably 5-20% w/w, and most preferably 8-18% w/w.

Numbered embodiment 28. The method according to any one of the preceding numbered embodiments wherein the whey lipid concentrate comprises carbohydrate in an amount of 3-24% w/w, more preferably 3-24% w/w, and most preferably 4-24% w/W.

Numbered embodiment 29. The method according to any one of the preceding numbered embodiments wherein the whey lipid concentrate comprises carbohydrate in an amount of 5-24% w/w, more preferably 5-20% w/w, and most preferably 8-18% w/w.

Numbered embodiment 30. The method according to any one of the preceding numbered embodiments wherein the whey lipid concentrate comprises lactose in an amount of at most 2% w/w, more preferably at most 1% w/w, even more preferably at most 0.5% w/w, and most preferably at most 0.1% w/w.

Numbered embodiment 31. The method according to any one of the preceding numbered embodiments wherein the whey lipid concentrate comprises carbohydrate in an amount of at most 2% w/w, more preferably at most 1% w/w, even more preferably at most 0.5% w/w, and most preferably at most 0.1% w/w.

Numbered embodiment 32. The method according to any one of the preceding numbered embodiments, wherein the whey lipid concentrate has a total plate count of more than 100 colony forming units (CFU) per kg TS, more preferably at least 500 CFU/kg TS, even more preferably at least 2000 CFU/kg TS, and most preferably at least 5000 CFU/kg TS.

Numbered embodiment 33. The method according to any one of the preceding numbered embodiments, wherein the whey lipid concentrate has a total plate count of more than 500 colony forming units (CFU) per g TS, more preferably at least 1000 CFU/g TS, even more preferably at least 2000 CFU/g TS, and most preferably at least 5000 CFU/g TS.

Numbered embodiment 34. The method according to any one of the preceding numbered embodiments, wherein the whey lipid concentrate comprises 501-5*10⁷ CFU/g TS, more preferably 1000-5*10⁶, and most preferably 2000-1*10⁶ CFU/g TS.

Numbered embodiment 35. The method according to any one of the preceding numbered embodiments, wherein the whey lipid concentrate comprises total solids in an amount of 2-50% w/w, more preferably 5-45%, even more preferably 8-40% w/w, and most preferably 10-35% w/w.

Numbered embodiment 36. The method according to any one of the preceding numbered embodiments, wherein the whey lipid concentrate comprises total solids in an amount of 2-25% w/w, more preferably 5-20%, even more preferably 8-20% w/w, and most preferably 10-18% w/w.

Numbered embodiment 37. The method according to any one of the preceding numbered embodiments, wherein the whey lipid concentrate comprises total solids in an amount of 5-45% w/w, more preferably 10-40%, and most preferably 15-35% w/W.

Numbered embodiment 38. The method according to any one of the preceding numbered embodiments, wherein the whey lipid concentrate has a content of native immunoglobulin G of 5-17% w/w relative to total protein, more preferably 7-16% w/w, even more preferably 8-15% w/w, and most preferably 10-15% w/w relative to total protein.

Numbered embodiment 39. The method according to any one of the preceding numbered embodiments, wherein the weight ratio between native immunoglobulin G and total immunoglobulin G of the whey lipid concentrate is at least 0.5, more preferably at least 0.7, even more preferably at least 0.8, and most preferably at least 0.9.

Numbered embodiment 40. The method according to any one of the preceding numbered embodiments, wherein the whey lipid concentrate has a content of native lactoferrin of 0.1-1.2% w/w relative to total protein, more preferably 0.2-1.2% w/w, even more preferably 0.3-1.2% w/w, and most preferably 0.3-1.1% w/w relative to total protein.

Numbered embodiment 41. The method according to any one of the preceding numbered embodiments, wherein the whey lipid concentrate has a content of native lactoferrin of 0.2-1.5% w/w relative to total protein, more preferably 0.3-1.5% w/w, even more preferably 0.4-1.5% w/w, and most preferably 0.5-1.5% w/w relative to total protein

Numbered embodiment 42. The method according to any one of the preceding numbered embodiments, wherein the weight ratio between native lactoferrin and total lactoferrin of the whey lipid concentrate is at least 0.3, more preferably at least 0.4, even more preferably at least 0.5, and most preferably at least 0.6.

Numbered embodiment 43. The method according to any one of the preceding numbered embodiments, wherein the whey lipid concentrate comprises at most 10% w/w casein relative to the total amount of protein, preferably at most 5% w/w, more preferably at most 1% w/w, and even more preferably at most 0.5% casein relative to the total amount of protein.

Numbered embodiment 44. The method according to any one of the preceding numbered embodiments, wherein the whey lipid concentrate has a content of native beta-lactoglobulin in the range of 10-45% w/w relative to total protein, more preferably 15-40% w/w, even more preferably 20-40% w/w, and most preferably 25-35% w/w relative to total protein.

Numbered embodiment 45. The method according to any one of the preceding numbered embodiments, wherein the whey lipid concentrate has a content of alpha-lactalbumin in the range of 0-15% w/w relative to total protein, more preferably 0.1-10% w/w, even more preferably 0.3-9% w/w, and most preferably 0.5-7% w/w relative to total protein.

Numbered embodiment 46. The method according to any one of the preceding numbered embodiments, wherein the whey lipid concentrate has a content of alpha-lactalbumin in the range of 1-10% w/w relative to total protein, more preferably 1-9% w/w, even more preferably 2-8% w/w, and most preferably 3-7% w/w relative to total protein.

Numbered embodiment 47. The method according to any one of the preceding numbered embodiments, wherein the whey lipid concentrate has a content of caseinomacropeptide in the range of 0-10% w/w relative to total protein, more preferably 1-8% w/w, even more preferably 2-7% w/w, and most preferably 3-7% w/w relative to total protein.

Numbered embodiment 48. The method according to any one of the preceding numbered embodiments, wherein the whey lipid concentrate has a content of caseinomacropeptide in the range of 0-9% w/w relative to total protein, more preferably 0.1-7% w/w, even more preferably 0.3-5% w/w, and most preferably 0.5-3% w/w relative to total protein.

Numbered embodiment 49. The method according to any one of the preceding numbered embodiments, wherein the whey lipid concentrate has a content of osteopontin in the range of 0.9-5% w/w relative to total protein, more preferably 1.0-4% w/w, even more preferably 1.1-3% w/w, and most preferably 1.1-1.7% w/w relative to total protein.

Numbered embodiment 50. The method according to any one of the preceding numbered embodiments, wherein the whey lipid concentrate has a content of osteopontin in the range of 2.0-5% w/w relative to total protein, more preferably 2.2-4.5% w/w, even more preferably 2.5-4.0% w/w, and most preferably 3.0-3.7% w/w relative to total protein.

Numbered embodiment 51-54 are deliberately missing.

Numbered embodiment 55. The method according to any one of the preceding numbered embodiments, wherein the whey lipid concentrate has an ash content of 0.3-6% w/w relative to total solids, more preferably 0.5-5% w/w, even more preferably 1.0-4% w/w, and most preferably 1.2-3.5% w/w relative to total solids.

Numbered embodiment 56. The method according to any one of the preceding numbered embodiments, wherein the whey lipid concentrate has an ash content of 0.3-2% w/w relative to total solids, more preferably 0.4-1.5% w/w, and most preferably 0.5-1.0% w/w relative to total solids.

Numbered embodiment 57. The method according to any one of the preceding numbered embodiments, wherein the whey lipid concentrate has a content of Fe(II) in an amount of 2-50 mg per kg protein, more preferably 3-30 mg per kg protein, even more preferably 4-15 mg per kg protein, and most preferably 5-10 mg per kg protein.

Numbered embodiment 58. The method according to any one of the preceding numbered embodiments, wherein the whey lipid concentrate has pH of 4.0-8, more preferably 5.5-7.5, even more preferably 5.7-7.0, and most preferably 5.9-6.6.

Numbered embodiment 59. The method according to any one of the preceding numbered embodiments, wherein the whey lipid concentrate has a temperature in the range of 1-59 degrees C, more preferably 2-20 °C, even more preferably 3-15 °C, and most preferably 3-10 °C.

Numbered embodiment 60. The method according to any one of the preceding numbered embodiments wherein the heat-treatment of step b) involves indirect heating.

Numbered embodiment 61. The method according to any one of the preceding numbered embodiments wherein the heat-treatment of step b) involves direct heating.

Numbered embodiment 62. The method according to any one of the preceding numbered embodiments wherein the heat-treatment of step b) involves indirect heating followed by direct heating.

Numbered embodiment 63. The method according to numbered embodiment 60 wherein the indirect heating involve one of more of heating via a plate heat exchanger, a tubular heat exchanger, and a scraped-surface heat exchanger.

Numbered embodiment 64. The method according to numbered embodiment 61 wherein the direct heating involve one of more of heating via steam infusion, direct steam injection, ohmic heating, and microwave heating.

Numbered embodiment 64. The method according to any one of the preceding numbered embodiments wherein any heating performed when the whey lipid concentrate has a temperature above 60 °C is performed by direct heating.

Numbered embodiment 65. The method according to any one of the preceding numbered embodiments wherein any heating performed when the whey lipid concentrate has a temperature above 62 °C is performed by direct heating.

Numbered embodiment 66. The method according to any one of the preceding numbered embodiments wherein any heating performed when the whey lipid concentrate has a temperature above 63 °C is performed by direct heating.

Numbered embodiment 67. The method according to any one of the preceding numbered embodiments wherein the heat-treatment of step b) comprises or even consists of heating by steam infusion.

Numbered embodiment 68. The method according to any one of the preceding numbered embodiments wherein the heat-treatment of step b) comprises heating the whey lipid concentrate by indirect heating and subsequently further heating the whey lipid concentrate by direct heating.

Numbered embodiment 69. The method according to any one of the preceding numbered embodiments wherein the heat-treatment of step b) comprises heating the whey lipid concentrate to a temperature of at least 50 °C by indirect heating and subsequently further heating the whey lipid concentrate to at least 63 °C by direct heating.

Numbered embodiment 70. The method according to any one of the preceding numbered embodiments wherein the heat-treatment of step b) comprises heating the whey lipid concentrate to a temperature of at least 50 °C by indirect heating and subsequently further heating the whey lipid concentrate to the target temperature by direct heating.

Numbered embodiment 71. The method according to any one of the preceding numbered embodiments wherein at least 50% of the denaturation of lactoferrin during step b) occurs at the target temperature, more preferably at least 60%, even more preferably at least 70%, and most preferably at least 80% of the denaturation of lactoferrin during step b).

Numbered embodiment 72. The method according to any one of the preceding numbered embodiments wherein the duration of the temperature ramp-up phase of step b) is preferably at most 20 seconds, more preferably at most 10 seconds, even more preferably at most 8 seconds, and most preferably at most 4 seconds.

Numbered embodiment 73. The method according to any one of the preceding numbered embodiments wherein the duration of the temperature ramp-up phase of step b) is at most 2 second, more preferably at most 1 second, and most preferably at most 0.5 seconds.

Numbered embodiment 74. The method according to any one of the preceding numbered embodiments wherein the duration of the cooling phase of step b) is preferably at most 20 seconds, more preferably at most 10 seconds, even more preferably at most 8 seconds, and most preferably at most 4 seconds.

Numbered embodiment 75. The method according to any one of the preceding numbered embodiments wherein the duration of the cooling phase of step b) is at most 2 second, more preferably at most 1 second, and most preferably at most 0.5 seconds.

Numbered embodiment 76. The method according to any one of the preceding numbered embodiments wherein the holding time of the heat-treatment of step b) is selected so that the heat-treatment of step b) is capable of reducing the total plate count of a whey lipid concentrate by at least 99.9%.

Numbered embodiment 77. The method according to any one of the preceding numbered embodiments wherein the holding time of the heat-treatment of step b) is selected so that the heat-treatment of step b) is capable of reducing the total plate count of a whey lipid concentrate by at least 99.99%.

Numbered embodiment 78. The method according to any one of the preceding numbered embodiments wherein the target temperature and the holding time of the heat-treatment of step b) is sufficient to denature at most 80% w/w of the native beta-lactoglobulin of the whey lipid concentrate, more preferably at most 60% of the native beta-lactoglobulin of the whey lipid concentrate, even more preferably at most 50% w/w of the native beta-lactoglobulin of the whey lipid concentrate, and most preferably at most 45% w/w of the native beta-lactoglobulin of the whey lipid concentrate.

Numbered embodiment 79. The method according to any one of the preceding numbered embodiments wherein the target temperature and a holding time of the heat-treatment of step b) is sufficient to denature at most 40% w/w of the native beta-lactoglobulin of the whey lipid concentrate, more preferably at most 30% of the native beta-lactoglobulin of the whey lipid concentrate, even more preferably at most 20% w/w of the native beta-lactoglobulin of the whey lipid concentrate, and most preferably at most 10% w/w of the native beta-lactoglobulin of the whey lipid concentrate.

Numbered embodiment 80. The method according to any one of the preceding numbered embodiments wherein the heat-treatment of step b) denatures at most 80% w/w of the native beta-lactoglobulin of the whey lipid concentrate, more preferably at most 60% of the native beta-lactoglobulin of the whey lipid concentrate, even more preferably at most 50% w/w of the native beta-lactoglobulin of the whey lipid concentrate, and most preferably at most 45% w/W of the native beta-lactoglobulin of the whey lipid concentrate.

Numbered embodiment 81. The method according to any one of the preceding numbered embodiments wherein the heat-treatment of step b) denatures at most 40% w/w of the native beta-lactoglobulin of the whey lipid concentrate, more preferably at most 30% of the native beta-lactoglobulin of the whey lipid concentrate, even more preferably at most 20% w/w of the native beta-lactoglobulin of the whey lipid concentrate, and most preferably at most 10% w/w of the native beta-lactoglobulin of the whey lipid concentrate.

Numbered embodiment 82. The method according to any one of the preceding numbered embodiments wherein the target temperature of the heat-treatment of step b) is in the range 70-75 °C and the holding time is the range of 1-60 seconds.

Numbered embodiment 83. The method according to any one of the preceding numbered embodiments wherein the target temperature of the heat-treatment of step b) is in the range of 71-74 °C and the a holding time is in the range of 5-30 seconds.

Numbered embodiment 84. The method according to any one of the preceding numbered embodiments wherein the heat-treatment of step b) employs combination of target temperature and holding time which is capable of providing a level of reduction of Coxiella burnetii in the whey lipid concentrate which is at least equivalent to heat-treatment to a target temperature of 72 °C with a holding time of 15 seconds.

Numbered embodiment 85. The method according to any one of the preceding numbered embodiments wherein step b) furthermore involves cooling the heat-treated whey lipid concentrate, preferably to a temperature of less than 60 °C.

Numbered embodiment 86. The method according to numbered embodiment 85, wherein the cooling involves indirect cooling, e.g. using a plate heat exchanger or a tubular heat exchanger, and/or flash cooling.

Numbered embodiment 87. The method according to any one of the preceding numbered embodiments wherein the heat-treated whey lipid concentrate obtained from step b) is sent directly to the drying of step c).

Numbered embodiment 88. The method according to any one of the preceeding numbered embodiments wherein the heat-treated whey lipid concentrate is not subjected to a cooling step prior to the drying of step c).

Numbered embodiment 89. The method according to any one of the preceding numbered embodiments wherein the drying of step c) involves spray-drying.

Numbered embodiment 90. The method according to any one of the preceding numbered embodiments wherein the liquid composition that is dried in step c) comprises the heat-treated whey lipid concentrate obtained from step b).

Numbered embodiment 91. The method according to any one of the preceding numbered embodiments wherein the liquid composition that is dried in step c) is the heat-treated whey lipid concentrate obtained from step b).

Numbered embodiment 92. The method according to any one of the preceding numbered embodiments wherein the liquid composition that is dried in step c) is a protein concentrate of the heat-treated whey lipid concentrate obtained from step b), preferably the obtained by evaporation, or concentration by reverse osmosis of the heat-treated whey lipid concentrate obtained from step b).

Numbered embodiment 93. The method according to any one of the preceding numbered embodiments wherein c) is performed under aseptic conditions.

Numbered embodiment 94. A whey-derived powder enriched with respect to whey lipid, the whey-derived powder having:
a content of phospholipid of at least 1.5% w/w relative to total solids,
a weight ratio between phospholipid and total protein of at least 0.04,
a content of carbohydrate of at most 70% w/w relative to TS, preferably wherein lactose comprises at least 50% w/w of the carbohydrate,
a total solids content of at least 92% w/w,
preferably, a content of native immunoglobulin G of 1-17% w/w relative to total protein,
preferably, a content of native lactoferrin of 0.1-1.5% w/w relative to total protein, said whey-derived powder having one or more of, and more preferably all of, the following characteristics:
a total plate count of at most 1000000 CFU/100 g the whey-derived powder,
Cronobacter species are absent in at least 30 samples of 10 g of the whey-derived powder,
Salmonella species are absent in at least 30 samples of 25 g of the whey-derived powder, and
Enterobacteriaceae species are absent in at least 10 samples of 10 g of the whey-derived powder.

Numbered embodiment 94a. The whey-derived powder according to numbered embodiment 94 comprises phospholipid in an amount of at least 1.5% w/w total solids, more preferably at least 3% w/w TS, even more preferably at least 5% w/w TS, and most preferably at least 6% w/w TS.

Numbered embodiment 94b. The whey-derived powder according to any one of the numbered embodiments 94-94a wherein the whey-derived powder comprises phospholipid in an amount of at 1.5-12% w/w TS.

Numbered embodiment 94c. The whey-derived powder according to any one of the numbered embodiments 94-94b wherein the whey-derived powder comprises phospholipid in an amount of at 4.0-12% w/w TS, more preferably 4.5-10% w/w TS, even more preferably 5.0-9% w/w TS, and most preferably 5.5-8.5% w/w TS.

Numbered embodiment 95. The whey-derived powder according to any one of the numbered embodiments 94-94c, wherein the whey-derived powder comprises phospholipid in an amount of at 1.5-10% w/w TS, more preferably 1.6-8% w/w TS, even more preferably 1.8-6% w/w TS, and most preferably 3-5.5% w/w TS.

Numbered embodiment 96. The whey-derived powder according to any one of the numbered embodiments 94-95 wherein the whey-derived powder comprises total lipid in an amount of at least 3% w/w TS, more preferably at least 6% w/w TS, even more preferably at least 10% w/w TS, and most preferably at least 16% w/w TS.

Numbered embodiment 97. The whey-derived powder according to any one of the numbered embodiments 94-96 wherein the whey-derived powder comprises lipid in an amount of at 8-30% w/w total solids, more preferably 10-26% w/w TS, even more preferably 12-24% w/w TS, and most preferably 15-22% w/w TS.

Numbered embodiment 98. The whey-derived powder according to any one of the numbered embodiments 94-97 wherein the whey-derived powder comprises lipid in an amount of at 3.0-20% w/w total solids, more preferably 3.5-16% w/w TS, even more preferably 4-12% w/w TS, and most preferably 7-11% w/w TS.

Numbered embodiment 99. The whey-derived powder according to any one of the numbered embodiments 94-98, wherein the whey-derived powder has a weight ratio between phospholipid and total lipid of 0.20-0.50, more preferably 0.25-0.45, and most preferably 0.30-0.40.

Numbered embodiment 100. The whey-derived powder according to any one of the numbered embodiments 94-99, wherein the whey-derived powder has a weight ratio between phospholipid and total protein of at least 0.04, more preferably at least 0.06, even more preferably at least 0.08, and most preferably at least 0.09.

Numbered embodiment 101. The whey-derived powder according to any one of the numbered embodiments 94-100, wherein the whey-derived powder has a weight ratio between phospholipid and total protein in the range of 0.04-0.25, more preferably 0.07-0.20, even more preferably 0.08-0.17, and most preferably 0.09-0.15.

Numbered embodiment 102. The whey-derived powder according to any one of the numbered embodiments 94-101, wherein the whey-derived powder comprises total protein in an amount in the range of at least 20% w/w TS, and most preferably at least 25% w/w TS.

Numbered embodiment 103. The whey-derived powder according to any one of the numbered embodiments 94-102, wherein the whey-derived powder comprises total protein in an amount in the range of 20-80% w/w TS, and most preferably 25-75% w/w TS.

Numbered embodiment 104. The whey-derived powder according to any one of the numbered embodiments 94-103, wherein the whey-derived powder comprises total protein in an amount of at least 60% w/w TS, and most preferably at least 65% w/w TS.

Numbered embodiment 105. The whey-derived powder according to any one of the numbered embodiments 94-104, wherein the whey-derived powder comprises total protein in an amount in the range of 60-80% w/w TS, more preferably 65-80% w/w TS, and most preferably 70-75% w/w TS.

Numbered embodiment 106. The whey-derived powder according to any one of the numbered embodiments 94-105, wherein the whey-derived powder comprises total protein in an amount less than 60% w/w TS, more preferably at most 55 w/w TS, and most preferably at most 50 w/w TS.

Numbered embodiment 107. The whey-derived powder according to any one of the numbered embodiments 94-106, wherein the whey-derived powder comprises total protein in an amount in the range of 20-60% w/w TS, more preferably 20-55% w/w TS, and most preferably 20-50% w/w TS.

Numbered embodiment 108. The whey-derived powder according to any one of the numbered embodiments 94-107, wherein the whey-derived powder comprises total protein in an amount in the range of 22-50% w/w TS, more preferably 24-45% w/w TS, and most preferably 25-40% w/w TS.

Numbered embodiment 109. The whey-derived powder according to any one of the numbered embodiments 94-108 wherein the whey-derived powder comprises carbohydrate in an amount of 0-70% w/w TS.

Numbered embodiment 110. The whey-derived powder according to any one of the numbered embodiments 94-109 wherein the whey-derived powder comprises lactose in an amount of less than 25% w/w TS, more preferably at most 15% w/w TS, even more preferably at most 6% w/w TS, and most preferably at most 2% w/w TS.

Numbered embodiment 111. The whey-derived powder according to any one of the numbered embodiments 94-110 wherein the whey-derived powder comprises carbohydrate in an amount of less than 25% w/w TS, more preferably at most 15% w/w TS, even more preferably at most 6% w/w TS, and most preferably at most 2% w/w TS.

Numbered embodiment 112. The whey-derived powder according to any one of the numbered embodiments 94-111 wherein the whey-derived powder comprises lactose in an amount of 25-70% w/w TS, more preferably 35-70% w/w TS, and most preferably 40-70% w/w TS.

Numbered embodiment 113. The whey-derived powder according to any one of the numbered embodiments 94-112 wherein the whey-derived powder comprises lactose in an amount of 45-70% w/w TS, more preferably 50-70% w/w TS, and most preferably 50-65% w/w TS.

Numbered embodiment 114. The whey-derived powder according to any one of the numbered embodiments 94-113 wherein the whey-derived powder comprises carbohydrate in an amount of 25-70% w/w TS, more preferably 35-70% w/w TS, and most preferably 40-70% w/w TS.

Numbered embodiment 115. The whey-derived powder according to any one of the numbered embodiments 94-114 wherein the whey-derived powder comprises carbohydrate in an amount of 45-70% w/w TS, more preferably 50-70% w/w TS, and most preferably 50-65% w/w TS.

Numbered embodiment 116. The whey-derived powder according to any one of the numbered embodiments 94-115 wherein the whey-derived powder comprises lactose in an amount of 2-24% w/w, more preferably 3-24% w/w, and most preferably 4-24% w/W.

Numbered embodiment 117. The whey-derived powder according to any one of the numbered embodiments 94-116 wherein the whey-derived powder comprises lactose in an amount of 5-25% w/w, more preferably 5-20% w/w, and most preferably 8-18% w/w.

Numbered embodiment 118. The whey-derived powder according to any one of the numbered embodiments 94-117 wherein the whey-derived powder comprises carbohydrate in an amount of 3-24% w/w, more preferably 3-24% w/w, and most preferably 4-24% w/W.

Numbered embodiment 119. The whey-derived powder according to any one of the numbered embodiments 94-118 wherein the whey-derived powder comprises carbohydrate in an amount of 5-25% w/w, more preferably 5-20% w/w, and most preferably 8-18% w/w.

Numbered embodiment 120. The whey-derived powder according to any one of the numbered embodiments 94-119 wherein the whey-derived powder comprises lactose in an amount of at most 2% w/w, more preferably at most 1% w/w, even more preferably at most 0.5% w/w, and most preferably at most 0.1% w/w.

Numbered embodiment 121. The whey-derived powder according to any one of the numbered embodiments 94-120 wherein the whey-derived powder comprises carbohydrate in an amount of at most 2% w/w, more preferably at most 1% w/w, even more preferably at most 0.5% w/w, and most preferably at most 0.1% w/w.

Numbered embodiment 123. The whey-derived powder according to any one of the numbered embodiments 94-122 having a total plate count of at most 700000 colony forming units (CFU) per 100 g powder, more preferably at most 500000 CFU/100 g powder, and most preferably at most 100000 CFU/100 g powder.

Numbered embodiment 124. The whey-derived powder according to any one of the numbered embodiments 94-123 having a total plate count of at most 50000 colony forming units (CFU) per 100 g powder, more preferably at most 10000 CFU/100 g powder, even more preferably at most 3000 CFU/100 g powder, and most preferably at most 500 CFU/100 g powder.

Numbered embodiment 125. The whey-derived powder according to any one of the numbered embodiments 94-124 wherein the whey-derived powder furthermore has the following characteristics:
is free from Cronobacter species,
is free from Salmonella species, and
is free from Enterobacteriaceae.

Numbered embodiment 126. The whey-derived powder according to any one of the numbered embodiments 94-125, wherein the whey-derived powder is sterile.

Numbered embodiment 127. The whey-derived powder according to any one of the numbered embodiments 94-126, wherein the whey-derived powder comprises total solids in an amount of 92-99% w/w, more preferably 93-98%, and most preferably 94-98% w/w.

Numbered embodiment 128. The whey-derived powder according to any one of the numbered embodiments 94-127, wherein the whey-derived powder has a content of native immunoglobulin G of 5-17% w/w relative to total protein, more preferably 7-16% w/w, even more preferably 8-15% w/w, and most preferably 10-15% w/w relative to total protein.

Numbered embodiment 129. The whey-derived powder according to any one of the numbered embodiments 94-128, wherein the weight ratio between native immunoglobulin G and total immunoglobulin G of the whey lipid concentrate is at least 0.5, more preferably at least 0.7, even more preferably at least 0.8, and most preferably at least 0.9.

Numbered embodiment 130. The whey-derived powder according to any one of the numbered embodiments 94-129, wherein the whey-derived powder has a content of native lactoferrin of 0.1-1.2% w/w relative to total protein, more preferably 0.2-1.2% w/w, even more preferably 0.3-1.2% w/w, and most preferably 0.3-1.1% w/w relative to total protein.

Numbered embodiment 131. The whey-derived powder according to any one of the numbered embodiments 94-130, wherein the whey-derived powder has a content of native lactoferrin of 0.2-1.5% w/w relative to total protein, more preferably 0.3-1.5% w/w, even more preferably 0.4-1.5% w/w, and most preferably 0.5-1.5% w/w relative to total protein.

Numbered embodiment 132. The whey-derived powder according to any one of the numbered embodiments 94-131, wherein the weight ratio between native lactoferrin and total lactoferrin of the whey lipid concentrate is at least 0.3, more preferably at least 0.4, even more preferably at least 0.5, and most preferably at least 0.6.

Numbered embodiment 133. The whey-derived powder according to any one of the numbered embodiments 94-132, wherein whey-derived powder comprises at most 10% w/w casein relative to the total amount of protein, preferably at most 5% w/w, more preferably at most 1% w/w, and even more preferably at most 0.5% casein relative to the total amount of protein.

Numbered embodiment 134. The whey-derived powder according to any one of the numbered embodiments 94-133, wherein whey-derived powder comprises a total amount of beta-lactoglobulin in the range of 10-45% w/w relative to total protein, more preferably 15-40% w/w, even more preferably 20-40% w/w, and most preferably 25-35% w/w relative to total protein.

Numbered embodiment 135. The whey-derived powder according to any one of the numbered embodiments 94-134, wherein whey-derived powder comprises a total amount of alpha-lactalbumin in the range of 0-15% w/w relative to total protein, more preferably 0.1-10% w/w, even more preferably 0.3-9% w/w, and most preferably 0.5-7% w/w relative to total protein.

Numbered embodiment 136. The whey-derived powder according to any one of the numbered embodiments 94-137, wherein whey-derived powder comprises a total amount of alpha-lactalbumin in the range of 1-10% w/w relative to total protein, more preferably 1-9% w/w, even more preferably 2-8% w/w, and most preferably 3-7% w/w relative to total protein.

Numbered embodiment 137. The whey-derived powder according to any one of the numbered embodiments 94-136, wherein whey-derived powder comprises a total amount of caseinomacropeptide in the range of 0-10% w/w relative to total protein, more preferably 1-8% w/w, even more preferably 2-7% w/w, and most preferably 3-7% w/w relative to total protein.

Numbered embodiment 138. The whey-derived powder according to any one of the numbered embodiments 94-137, wherein whey-derived powder comprises a total amount of caseinomacropeptide in the range of 0-9% w/w relative to total protein, more preferably 0.1-7% w/w, even more preferably 0.3-5% w/w, and most preferably 0.5-3% w/w relative to total protein.

Numbered embodiment 139. The whey-derived powder according to any one of the numbered embodiments 94-138, wherein the whey-derived powder has an ash content of 0.3-6% w/w relative to total solids, more preferably 0.5-5% w/w, even more preferably 1.0-4% w/w, and most preferably 1.2-3.5% w/w relative to total solids.

Numbered embodiment 140. The whey-derived powder according to any one of the numbered embodiments 94-139, wherein the whey-derived powder has an ash content of 0.3-2% w/w relative to total solids, more preferably 0.4-1.5% w/w, and most preferably 0.5-1.0% w/w relative to total solids.

Numbered embodiment 141. The method according to any one of the numbered embodiments 94-140, wherein the whey-derived powder has a content of Fe(II) in an amount of 2-50 mg per kg protein, more preferably 3-30 mg per kg protein, even more preferably 4-15 mg per kg protein, and most preferably 5-10 mg per kg protein.

Numbered embodiment 142. The whey-derived powder according to any one of the numbered embodiments 94-141, wherein the whey-derived powder has pH of 4.0-8, more preferably 5.5-7.5, even more preferably 5.7-7.0, and most preferably 5.9-6.6.

Numbered embodiment 143. The whey-derived powder according to any one of the numbered embodiments 94-142, in the form of a packaged whey-derived powder comprising a container containing the whey-derived powder, preferably wherein the container is sealed.

Numbered embodiment 144. The whey-derived powder according to numbered embodiment 143, wherein the container is a bag, a barrel, a pouch, a box, a can, and a sachet.

Numbered embodiment 145. The whey-derived powder according to any one of numbered embodiments 94-144 in a quantity of at least 10 kg, more preferably at least 20 kg, even more preferably at least 30 kg, and most preferably at least 50 kg.

Numbered embodiment 146. The whey-derived powder according to any one of numbered embodiments 94-145 obtainable by the method according to one or more of numbered embodiments 1-93.

Numbered embodiment 147. A plurality of sealed containers, preferably in the form of sacks or bags, each container holding the whey-derived powder according to one or more of numbered embodiments 94-146 in an amount in the range of 10-100 kg/container.

Numbered embodiment 148. The plurality of sealed containers according to numbered embodiment 147, comprising at least 5 sealed containers.

Numbered embodiment 149. The plurality of sealed containers according to numbered embodiment 147 or 148, wherein the container is a bag, a barrel, a pouch, a box, a can, or a sachet.

Numbered embodiment 150. The plurality of sealed containers according to any one of numbered embodiments 147-149, wherein the container is a bag.

Numbered embodiment 151. Use of the whey-derived powder according to any one of numbered embodiments 94-146 as a food ingredient, for preparing a nutritional product, preferably for paediatric nutrition, and more preferably an infant formula product in powder form.

Numbered embodiment 152. Use according to numbered embodiment 151 wherein the nutritional product is prepared by dry-blending the whey-derived powder according to any one of numbered embodiment 94-146 with:
one or more additional powder ingredient(s), and
optionally, further powder ingredient comprising of probiotic bacteria.

153. A process of producing a nutritional powder, preferably for paediatric nutrition, and more preferably an infant formula, the process comprising dry-blending the whey-derived powder with:
one or more additional powder ingredient(s), and
optionally, a further powder ingredient comprising of probiotic bacteria, preferably, wherein the one or more additional powder ingredient(s) have the following characteristics:
a total plate count of at most 1000000 CFU/100 g ingredient powder, and more preferably at most 50000 CFU/100 g ingredient powder,
Cronobacter species are absent in at least 30 samples of 10 g ingredient powder,
Salmonella species are absent in at least 30 samples of 25 g ingredient powder, and
Enterobacteriaceae species are absent in at least 10 samples of 10 g ingredient powder.

Numbered embodiment 154. A nutritional powder which is a dry-blend of the whey-derived powder according to one or more of numbered embodiments 94-146 and one or more additional powder ingredient(s), and optionally a further powder ingredient comprising of probiotic bacteria.

Numbered embodiment 155. A nutritional powder according to numbered embodiment 154 wherein the combination of the one or more additional ingredients have the following characteristics:
a total plate count of at most 1000000 CFU/100 g ingredient powder, and more preferably at most 50000 CFU/100 g ingredient powder,
Cronobacter species are absent in at least 30 samples of 10 g ingredient powder,
Salmonella species are absent in at least 30 samples of 25 g ingredient powder, and
Enterobacteriaceae species are absent in at least 10 samples of 10 g ingredient powder.

Numbered embodiment 156. A nutritional powder according to numbered embodiment 154 or 155 wherein each of the one or more additional ingredients have the following characteristics:
a total plate count of at most 50000 CFU/100 g total solids,
are free from Cronobacter species,
are free from Samonella species, and
are free from Enterobacteriaceae.

Numbered embodiment 157. The nutritional powder according to any one of the numbered embodiments 154-156 which is prepared by dry-blending of the one or more additional ingredients.

Numbered embodiment 158. The nutritional powder according to any one of the numbered embodiments 154-157 in the form of a paediatric product such as e.g. an infant formula, a growing up formula, or a follow-on formula.

Numbered embodiment 159. The nutritional powder according to any one of the numbered embodiments 154-158 in the form of an infant formula.

Numbered embodiment 160. The nutritional powder according to any one of the numbered embodiments 154-159 which is nutritionally complete, preferably according to the regulations for Foods for Special Medical Purposes according to EU Regulation No 609/2013.

The present invention has been described above with reference to specific embodiments. However, other embodiments than the above described are equally possible within the scope of the invention. The different features and steps of various embodiments and aspects of the invention may be combined in other ways than those described herein unless it is stated otherwise. The invention will now be described in further details in the following non-limiting examples.

### EXAMPLES

### Methods of Analysis

The follow analyses should be used for determining the parameters mentioned herein.

The content of total solids of a composition is quantified according to Example 1.15 of WO 2020/002426.

The content of “total protein” or “protein” of a composition is quantified according to Example 1.5 of WO 2020/002426 and is a measure of the true protein of the composition.

The ash content of a composition is quantified according to Example 1.13 of WO 2020/002426 The content of BLG, ALA and CMP are quantified according to Example 1.6 of WO 2020/002426

The pH of a composition is measured according to Example 1.16 of WO 2020/002426.

The content of specific minerals of a composition is quantified according to Example 1.19 of WO 2020/002426.

The content of total lipid of a composition is quantified according to Example 1.27 of WO 2020/002426.

The content of native IgG is quantified by radial immuno diffusion.

The content of total IgG is quantified according to Ostertag et al, “Development and validation of an RP-HPLC DAD method for the simultaneous quantification of minor and major whey proteins”, Food Chemistry 342 (2021) 128176

The content of native lactoferrin is quantified according to Chen et al; “Determination of native lactoferrin in milk by HPLC on HiTrap™ Heparin HP column”; Food Analytical Methods (2019) 12:2518-2526.

The content of total lactoferrin is quantified according to Zhang et al.; “Determination of Bovine Lactoferrin in Food by HPLC with a Heparin Affinity Column for Sample Preparation”; Journal of AOAC International Vol. 100, No. 1, 2017.

The determination of colony-forming units is based on the total plate count after incubation at 30 °C according to ISO Standard 4833-1

The content of Cronobacter species is determined according to ISO Standard 22964.

The content of Salmonella species is determined according to ISO Standard 6579-1.

The content of Enterobacteriaceae is determined according to ISO Standard 21528-1.

The content of “phospholipid”, referring to the total phosphospholipid content is quantified according Christie et al, International Journal of Dairy Technology, Volume 40, Issue 1, Pages 10-12, 2007

The content of OPN is quantified according to Analysis 1 of PCT application no. PCT/EP2022/070107.

### Example 1-Production of a Dry-Blend Quality Powdered Whey-Derived Composition Enriched in Whey Lipids

A first liquid whey lipid concentrate (pre-wlc) was prepared by ultrafiltration (UF) of a bovine sweet whey until a protein content of approx. 70% of total solids was reached, and further subjecting the UF-retentate to microfiltration (MF; using a Synder FR membrane; nominal molecu-lar weight cut-off of 800 kDa; spiral-wound element with a polymeric membrane (polyvinylidene difluoride-based)). The microfiltration was performed using diafiltration with water as diluent. The MF-retentate was finally subjected to microbial reduction by MF-based germ filtration (using TAMI 1.4 micrometer Isoflux ceramic elements).

Another liquid whey lipid concentrate (wlc) used for heat-treament was prepared by diluting the pre-wlc to 18% total solids with demineralized water. The wlc was stored cold (<8 °C) until it was subjected to heat treatment on a pilot plant ‘DS Triple SSIN Infusion’ (steam infusion) to a target temperature of 72.5 °C using a holding cell which provided a holding time of 18 sec. After leaving the holding cell the heated wlc was cooled to <8 °C by a combination of a tubular heat exchanger (THE) and a plate heat exchanger (PHE).

The duration of the temperature ramp-up phase of the heat-treatment was less than 0.5 seconds. The duration of the cooling phase of the heat-treatment was less than 5 seconds. If flash cooling had been applied even faster cooling could have been achieved.

The heat-treated wlc was subsequently converted to a powder using an Anhydro MS400 pilot dryer with an inlet temperature of 200 °C and outlet temperature of 85 °C.

### Results:

The composition of the wlc and the obtained spray-dried powder is shown in Tables 1.1, 1.2, and 1.3 below.

TABLE 1.1
Chemical composition of the wlc and the wlc powder.

| | Ash | Lactose | Protein | Fat | PL | TS | |
|---|---|---|---|---|---|---|---|
| | (% | (% | (% | (% | (% | (% | |
| | w/w) | w/w) | w/w) | w/w) | w/w) | w/w) | pH |
| Wlc | 0.37 | 0.12 | 14.0 | n.d. | n.d. | 18.4 | 6.09 |
| Wlc powder | 1.91 | 0.53 | 73.0 | 17.4 | 6.3 | 95.6 | 6.18 |

(TS = total solids; PL = phospholipid; n.d. = not determined)

TABLE 1.2
Contents of native IgG and native LF in the wlc and the
wlc powder. The reduction refers to the reduction in the
weight percentages of IgG and LF (relative to total protein)
in the final powder relative to the liquid wlc.

| Weight percentage relative | |
|---|---|
| to total protein | Reduction |

| | IgG | LF | IgG | LF |
|---|---|---|---|---|
| Wlc | 7.88% | 0.57% | | |
| Wlc powder | 6.17% | 0.13% | 22% | 77% |

TABLE 1.3
Sialic acid and gangliosides in wlc and final powder

| | g/100 g protein | | % reduction | |
|---|---|---|---|---|
| | Sialic acid | Gangliosides | Sialic acid | Gangliosides |
| Wlc | 2.69 | 0.33 | | |
| Wlc powder | 2.53 | 0.30 | 6% | 8% |

The contents of cholesterol of the liquid wlc and the final wlc powder were also measured and no significant changes in content were found.

### Conclusion:

A heat treatment of a wlc at 72.5 °C for 18 sec using a steam infusion pilot equipment shows a reduction of native IgG and LF by approx. 40 and 74% respectively. The heat treatment furthermore caused a reduction in native beta-lactoglobulin by approx. 43% (data not shown). The content of sialic acid, gangliosides and cholesterol were not significantly affected by the combination of heat treatment and the drying process.

The steam infusion process could run for more than 3 hour without any severe fouling and the resulting heat-treated wlc having a total solids content 18% w/w of could be converted into a powder by spray-drying without any problems.

The inventors furthermore observed in other experiments that the present heat-treatment regime in combination with a prior MF-based germ filtration offered sufficient microbial reduction to allow for the production of “dry-blend grade” whey lipid powders.

The same wlc was further subjected to target temperatures above 74 °C (data not shown) and the inventors observed that the content of both native IgG and native LF was further reduced by increasing temperature.

The pre-wlc could also have been used as the wlc in this example but it was found preferable to operate with a total solids content of at most 18% w/w.

### Example 2-Comparison of ‘Dry Blend’-Grade Heat Treatment of a Liquid Whey Lipid Concentrate: Plate Heat Exchanger (PHE) Vs. Steam Infusion (SI)

A liquid whey lipid concentrate (pre-wlc) was prepared as in Example 1.

The wlc used for heat-treatment was prepared by diluting the pre-wlc with demineralized water to a TS content of approx. 12% w/w. The wlc had a pH of approx. 6.1. The wlc was then split into 2 portions (Portions A and B).

Portion A was subjected to a heat treatment of 72 °C or 75 °C on a plate heat exchanger (PHE) at a flowrate of 330 l/h and a holding cell providing a holding time of 20 sec. After exiting the holding cell the wlc was cooled to 8 °C using a PHE. The duration of the temperature ramp-up phase was less than 5 seconds and the duration of the cooling phase was less than 5 seconds.

Portion B was heat treated on an SPX ‘UHT Infusion Stand Alone 100 l/h’ (Steam infusion) also at 72 °C or 75 °C at a flow rate of 100 l/h and a holding cell providing a holding time of 20 sec.

Prior to steam infusion the wlc was preheated to 50 °C and after exiting the holding cell the heated wlc was flash cooled to 35 °C. The duration of the temperature ramp-up phase was less than 0.5 second and the duration of the cooling phase was less than 0.5 second.

The level of protein denaturation caused by the heat-treatments were assess determining the degree of BLG denaturation caused by each heat-treatment.

### Results:

The chemical composition of the wlc prior to the heat-treatment and after each of the 4 heat-treatments are shown in Table 2.1. Here it is evident that the heat-treatments only caused insignificant changes in the contents of total solids, protein, lactose, fat, ash and phospholipid.

TABLE 2.1
Chemical composition of wlc before and after heat treatment

| | TS | Protein | Lactose | Fat | Ash | PL |
|---|---|---|---|---|---|---|
| | (% | (% | (% | (% | (% | (% |
| | w/w) | w/w) | w/w) | w/w) | w/w) | w/w) |
| wlc (before heating) | 11.25 | 8.27 | 0.13 | 2.06 | 0.25 | 0.72 |
| wlc after SI 72 °C 20 sec | 11.42 | 8.34 | n.d. | n.d. | 0.25 | 0.69 |
| wlc after SI 75 °C 20 sec | 11.42 | 8.39 | n.d. | n.d. | 0.26 | 0.76 |
| wlc after PHE 72 °C 20 | 11.24 | 8.23 | 0.14 | 2.08 | 0.26 | 0.70 |
| sec | | | | | | |
| wlc after PHE 75 °C 20 | 11.24 | 8.23 | 0.14 | 1.96 | 0.23 | 0.70 |
| sec | | | | | | |

(SI = steam infusion; PHE = plate heat exchanger; TS = total solids; PL = phospholipid; n.d. = not determined)

The changes of the degrees of BLG denaturation are shown in Table 2.2. Here it is apparent that heating by SI with rapid ramp-up and cooling phase gave rise to much lower denaturation than the comparable PHE-heating set-up. The denaturation of BLG can be used as marker for general protein denaturation.

TABLE 2.2
Degree of BLG denaturation obtained from heating by a plate-
heat exchanger (PHE) or by steam infusion (SI) for 20 seconds
at 72 degrees C and 75 degrees C respectively.

| | 72 degrees C/20 seconds | 75 degrees C/20 seconds |
|---|---|---|
| PHE | 50.9% | 77.4% |
| SI | 39.0% | 67.2% |

### Conclusion:

The wlc for heat treatment was diluted to 11.3% total solids, had a protein content of 73% TS and a phospholipid content of 6.1% TS. The proportion of phospholipid to protein was 0.088. Heating at 72 °C for 20 sec at a standard plate heat exchanger (PHE) showed a reduction in native beta-lactoglobulin (BLG) of 50.9%, while the reduction was only 39% when heated at the same temperature and duration on steam infusion (SI). When heated at 75 °C for 20 sec the reduction in native BLG was also higher when heated on a plate heat exchanger (PHE) compared to steam infusion (SI), 67.2% by SI compared to 77.4% by PHE.

These results indicate that heating a wlc by steam infusion using a rapid ramp-up and cooling phase will preserve heat sensitive compounds of whey lipid concentrates to a larger degree compared with a heat treatment with the same temperature and time on a standard plate heat exchanger (PHE) where the duration of the ramp-up phase and cooling phase is longer.

### Example 3-Impact of the Content of Lactose in the Liquid Whey Lipid Concentrate on the Heat Treatment Performed by PHE or SI

Five wlc samples were prepared by diluting the pre-wlcs (prepared according to Example 1 but from different batches) with demineralized water and by adding pure lactose to provide 13-18% w/w total solids and a lactose concentration of 6-8% w/w.

Trial 1: One of the wlc samples was subjected to a 72 °C heat treatment on a plate heat exchanger (PHE) at a flowrate of 330 l/h and holding cell of 18 sec. The duration of the temperature ramp-up phase was less than 5 seconds and the duration of the cooling phase was less than 5 seconds.

Trial 2-5: The four other wlc samples were subjected to a 72 °C heat treatment on a DS Triple SSIN Infusion (steam infusion, SI) at a flowrate of 150 l/h and holding cell of 18 sec. The duration of the temperature ramp-up phase was less than 0.5 second and the duration of the cooling phase was less than 0.5 second.

### Results:

The 5 heat treatment trials were performed with different wlc samples from different batches. The wlc samples used in trial 1 and trial 2 had the same lactose content and roughly the same lactose/TS. The PHE-based heat-treatment of 72 °C for 18 sec in trial 1 using a plate heat exchanger gave rise to a reduction in native IgG of 35% and a reduction of native LF of 65% (not shown in Table 3.2). The SI-based heating of trials 2-3 caused reductions of native IgG of 10-11%.

In trials 4 and 5 higher lactose contents were used (approx. 50% w/w lactose relative to TS) and here native IgG was not reduced when heating to 72 °C for 18 sec by steam infusion. However, reduction of native LF was still reduced by around 40%.

TABLE 3.1
Overview of the 5 trials wherein wlc samples comprising added
lactose were heated by PHE (trial 1) or SI (trials 2-5).

| | | Protein | Lactose | | | |
|---|---|---|---|---|---|---|
| | | of TS | of TS | TS | Lactose | Protein |
| Trial | | % | % | % | % | % |
| no | Raw material | (w/w) | (w/w) | (w/w) | (w/w) | (w/w) |
| 1 | wlc + lactose | 44.0 | 41.5 | 15.9 | 6.6 | 7.0 |
| | (PHE; 72 °C 18 sec) | | | | | |
| 2 | wlc + lactose | 48.3 | 37.1 | 17.8 | 6.6 | 8.6 |
| | (SI; 72 °C 18 sec) | | | | | |
| 3 | wlc + lactose | 47.7 | 46.9 | 13.0 | 6.1 | 6.2 |
| | (SI; 72 °C 18 sec) | | | | | |
| 4 | wlc + lactose | 38.6 | 50.0 | 17.6 | 8.8 | 6.8 |
| | (SI; 72 °C 18 sec) | | | | | |
| 5 | wlc + lactose | 39.1 | 49.6 | 13.3 | 6.6 | 5.2 |
| | (SI; 72 °C 18 sec) | | | | | |

TABLE 3.2
IgG-results of trials 1-5.

| | | Protein | Lactose | IgG | | |
|---|---|---|---|---|---|---|
| | | of TS | of TS | (g/100 g | | IgG |
| Trial | Raw material | % | % | protein) | | % re- |
| no | (process variant) | (w/w) | (w/w) | before | after | duction |
| 1 | wlc + lactose | 44.0 | 41.5 | 7.4 | 4.8 | 35 |
| | (PHE; 72 °C 18 sec) | | | | | |
| 2 | wlc + lactose | 48.3 | 37.1 | 7.0 | 6.2 | 11 |
| | (SI; 72 °C 18 sec) | | | | | |
| 3 | wlc + lactose | 47.7 | 46.9 | 7.0 | 6.3 | 10 |
| | (SI; 72 °C 18 sec) | | | | | |
| 4 | wlc + lactose | 38.6 | 50.0 | 7.8 | 7.9 | −1 |
| | (SI; 72 °C 18 sec) | | | | | |
| 5 | wlc + lactose | 39.1 | 49.6 | 7.8 | 7.7 | 1 |
| | (SI; 72 °C 18 sec) | | | | | |

In relation to lactoferrin, Trial 1 gave rise to a native lactoferrin reduction of 65% whereas the reduction in native lactoferrin of Trial 5 was only 40%.

### Conclusion:

The results with lactose at content of 50% lactose/TS, show that a wlc can be subjected to ‘dry blend’-grade heat-treatment without any reduction in native IgG. The content of native LF is still reduced on heat treating at high lactose levels but the reduction is lower (only 40% reduction) compared to heat-treatment at lower lactose contents (77% reduction at low levels of lactose in Example 1. In the experiments with 50% lactose/TS and heat treatment on steam infusion at 72 °C for 18 sec the estimated beta-lactoglobulin (BLG) reduction was 7-10% (data not shown).

The inventors furthermore observed in other experiments that the present heat-treatment regime in combination with a prior MF-based germ filtration offered sufficient microbial reduction to allow for the production of a high IgG/lactoferrin “dry-blend quality” whey lipid powders, i.e. powders with a low total plate count and in which Cronobacter species, Salmonella species and Enterobacteriaceae species are absent. A high content of carbohydrate is therefore not mandatory to achieve a “dry-blend quality” whey lipid powder containing high concentrations of native IgG and lactoferrin.

The present example also shows that ‘dry blend’-grade heat-treatment on a plate heat exchanger (PHE) caused more inactivation of both native IgG and LF compared with similar heat treatment (target temperature and time) on steam infusion (SI). This observation is in accordance with the lower denaturation of beta-lactoglobulin found in Example 2 when comparing heat treatment of a wlc with a plate heat exchanger vs. steam infusion.

### Example 4-Production of a Powdered Whey-Derived Composition Enriched in Whey Lipids, where Heat Treatment of the Whey Raw Material was Reduced to 63 °C

In this example the original cheese whey from which the pre-wlc was prepared, was heat treated at a temperature of only 63 °C for 15 sec (in comparison, the whey feeds used in the previous Examples to prepare the pre-wlc had been heat-treated at 72-74 °C for 15 seconds prior to production of the pre-wlc). This very gently heat-treated liquid whey was then processed according to Example 1 starting with the ultrafiltration and then the two microfiltration steps to provide the pre-wlc as described in Example 1.

In the present Example, the pre-wlc was used directly as wlc to be heated, and was heated by PHE to a target temperature of 63 °C for 15 sec and afterwards converted to a powder by spray-drying with an inlet temperature of 200 °C and outlet temperature of 85 °C.

### Results of Producing a ‘Bioactive’ Wlc Powder:

The composition of the wlc before and after heating as well as the resulting powder is shown in Table 4.1. The wlc powder had a phospholipid (PL) content of 5.4% and a protein content of 73.5% and thus a phospholipid to protein ratio of 0.073.

The content of native IgG in the wlc was 9.9 g IgG per 100 g of protein and native LF is 1.1 g LF per 100 g of protein, which is considerable higher than the untreated wlc in examples 1 and 3, where the whey raw material was heat treated at 72-74 °C for 15 sec.

In the present Example, the content of native IgG was neither decreased by the 63 °C heat treatment of the wlc nor by the spray drying process both yielding 9.8% native IgG per 100 g of protein.

The native lactoferrin (LF) per 100 g of protein was also higher in the untreated wlc compared to the untreated wlc in Examples 1 and 3, but LF was slightly decreased by the 63 °C heat treatment of the wlc and further decreased by the spray drying process. However, the content of native LF per 100 g of wlc powder in this example is still much higher than in the wlc powder in Example 1.

TABLE 4.1
Composition of the “low heat” wlc prior to and after the heat-
treatment at 63 °C/15 sec and of the resulting wlc powder.

| | | | phospho- | | | Lacto- |
|---|---|---|---|---|---|---|
| | TS | lactose | lipid | protein | IgG | ferrin |
| | % | % | % | % | g/100 g | g/100 g |
| | (w/w) | (w/w) | (w/w) | (w/w) | protein | protein |
| wlc | 24.2 | 0.31 | 1.4 | 18.6 | 9.9 | 1.1 |
| wlc after | 24.1 | 0.28 | 1.37 | 18.5 | 9.8 | 0.9 |
| 63 °C/15 sec | | | | | | |
| wlc powder | 94.9 | 1.2 | 5.4 | 73.5 | 9.8 | 0.8 |

TS = total solids

The ‘bioactive’ wlc powder described above was used to produce a ‘wet-blended’ infant formula powder with roughly 50% of the protein from skim milk powder and 50% of the protein from the present ‘bioactive’ wlc powder.

### Wet-Blend Infant Formula Process:

2.15 kg of skim milk powder (Milex 240), 5.74 kg of lactose powder (Variolac 992, Arla Foods Ingredients amba) and 1.00 kg of ‘bioactive’ wlc powder was added to 68.4 liter of demineralized water with a temperature of 58 °C and stirred for 1 hour. Hereafter 3.49 kg of vegetable fat (Laitao 06) at a temperature of 45 °C was added and the mixture was homogenized in a 2 step homogenizer at 125/25 bar.

After homogenization the following 6 suspensions/solutions were added to the mixture:
1. 40.6 g of citric acid in 772 g of dem. Water
2. 12.7 g magnesium chloride+17.5 g sodium chloride+8 g cholin chloride+13.8 g calcium carbonate in 208 g dem. Water
3. 10.7 g dipotassium hydrogen phosphate+12.7 g tricalcium phosphate in 93 g dem. Water
4. 10.8 g of mineral premix I (for infant formulas; contained 8.15 g of Fe(II) per 100 g of premix) dissolved in 131 g water (+3.8 g citric acid) 12.7 g of mineral premix II (for infant formulas; no Fe(II))+6.5 g L-arginine monohy-drochloride+1.2 g L carnitine in 183 g of dem. water
5. 15 g vitamin C in 285 g dem. water

Finally the mixture was pH adjusted to pH 6.6 by KOH (71.1 g of 46% KOH)

The infant formula mixture at 15% total solids was preheated on plate heat exchanger (PHE) to 80 °C and heat treated on DSI-UHT with a target temperature of 115 °C for 2 sec with a flow of 120 l/h. After the holding cell the infant formula mixture was flash cooled to 65 °C and the finally cooled to 8 °C on a plate heat exchanger (PHE). The heat treated infant formula mixture was the spray dried on a pilot spray drier with an inlet temperature of 180 °C and outlet temperature of 87 °C.

### Results of Adding ‘Bioactive’ Wlc Powder in the Wet-Blend Infant Formula Process:

The liquid infant formula mixture before heat treatment had a total solids content of 14.6% and a lactose content of 7.4%, resulting in an infant formula powder with a protein content of 12.2%, a lactose of 50.6% and a fat content of 27.4%. The phospholipid content of the infant formula powder was 0.45%. Later analysis of similar skim milk powder indicated a content of 0.12% w/w phospholipids, so the majority of phospholipids in the infant formula powder originated from the added wlc powder.

Both the contents of native IgG and LF were influenced by the heat treatment of the wet-mix infant formula concentrate. The IgG was almost totally denatured and around 80% of LF was denatured. The content of native IgG and LF in the skim milk powder used was below detection limits (data not shown).

### Conclusion:

Native IgG and LF in the wlc can be increased by reducing the initial heat treatment of the original whey source to 63 °C for 15 sec. When also reducing the heat treatment of the wlc to 63 °C for 15 sec, then a wlc (ready for spray-drying) with a high content of native IgG and native LF is achieved. This gentle processing resulted in a wlc powder with higher content of native IgG and native LF than in the wlc powder of Example 1.

However, when this ‘bioactive’ wlc powder was used to prepare an infant formula by the wet-blending process (where all ingredients are dissolved and mixed in water, then pasteurized and dried), then the all IgG is denatured and around 80% of native LF was denatured. Surprisingly, native IgG was more sensitive to heat treatment than LF in the infant formula mix, compared to the heat treatments of wlc on both steam infusion and plate heat exchanger in Example 1 and 3, where LF was more heat sensitive than IgG. An explanation for the higher heat stability of native LF compared to IgG in the wet-blended infant formula matrix, could be that the added ferro iron in the infant formula matrix turns the lactoferrin molecules to 100% iron saturated, which is a more heat stable form of LF.

TABLE 4.2
Composition of the wet-mix IF concentrate mixture prior to and after
the heat-treatment and of the final infant formula powder.

| | Wet-mix IF | Wet-mix IF | Infant formula |
|---|---|---|---|
| | mixture | mixture | powder (prepared |
| | before heat | after heat | by the wet- |
| | treatment | treatment | mixing process) |
| Total solids % | 14.6 | 14.7 | 95.5 |
| protein % | 1.9 | 1.9 | 12.2 |
| lactose % | 7.4 | 7.4 | 50.6 |
| fat % | 4.3 | 4.2 | 27.4 |
| Phospholipid % | 0.069 | 0.071 | 0.45 |
| ash % | 0.34 | 0.31 | 2.1 |
| Phosphorous % | 0.039 | 0.039 | 0.24 |
| Na % | 0.021 | 0.021 | 0.14 |
| Mg % | 0.0065 | 0.0064 | 0.045 |
| K % | 0.085 | 0.084 | 0.055 |
| Cl % | 0.04 | 0.05 | 0.33 |
| Ca % | 0.053 | 0.052 | 0.35 |
| pH | 6.67 | 6.72 | 6.69 |
| LF g per 100 g | 0.0075 | 0.0015 | 0.0091 |
| LF % of total protein | 0.40 | 0.08 | 0.075 |
| IgG g per 100 g | 0.095 | <10 | 0.0075 |
| IgG % of total protein | 5.1 | | 0.06 |

### Example 5-Production of a ‘Dry Blend’ Quality Powdered ‘Bioactive’ Whey-Derived Composition Enriched in Milk Fat Globular Membrane Components

The wlc in this example was produced in the same way as in Example 4. The phospholipid content was increased by increasing the diafiltration on the filtration step using Synder FR membrane. 350 kg of the wlc was added 280 kg 35% lactose solution and the resulting mixture was split into 2 portions, where one was added 350 mg Ferrous sulfate per 100 kg of wlc. The portion containing added Ferrous sulfate is referred to as wlc2 and the other portion is referred to as wlc1.

Both wlc portions were heat treated on a SPX ‘UHT Infusion Stand Alone 100 l/h’ with a target temperature of 74 °C at a flow rate of 100 l/h and a holding cell of 20 sec. Before steam infusion the wlc solution was preheated to 50 °C and after the holding cell flash cooled to 35 °C and then further cooled to 8 °C on a plate heat exchanger. The duration of the temperature ramp-up phase was less than 0.5 second and the duration of the cooling phase was less than 0.5 second.

Both heat-treated wlc portions were converted to a powder on an SPX MS750 pilot spray dryer with an inlet temperature of 200 °C and outlet temperature of 85 °C.

### Results:

The wlc had a content of total solids of 20%, a protein content of 15.2% (75.2% protein/TS) and a phospholipid content of 1.44% (7.1% PL/TS). After addition of 35% lactose solution the total solids of the wlc was increased to 25.8% and protein/TS was decreased to 36.8%. The lactose concentration in the wlc added lactose was 13.1%, which calculates to 50.8% lactose/TS.

The content of native IgG and LF in the untreated wlc retentate was 11.5 and 1.23 g per 100 g of protein. This level was neither influenced by the heat treatment at 74 °C for 20 sec nor the spray drying. The native LF was reduced by 50% to 0.65 g LF per 100 g of protein upon heat treatment and further slightly reduced to 0.63 g LF per 100 g protein upon spray drying. In wlc2 (incl. added lactose and ferrous sulphate) the LF was fully conserved as native LF both in the heat treated wlc and in the resulting wlc2 powder.

TABLE 5.1
Chemical composition of various process streams including the final wlc1 powder and wlc2 powder.

| | | | | | | | | IgG | LF |
|---|---|---|---|---|---|---|---|---|---|
| | Protein | Lactose | | | | | | g per | g per |
| | of TS | of TS | TS | Lactose | Phospholid | Fat | Protein | 100 g | 100 g |
| | % w/w | % w/w | % w/w | % w/w | % w/w | % w/w | % w/w | protein | protein |
| wlc | 75.2 | 0.7 | 20.2 | 0.15 | 1.44 | 3.8 | 15.2 | 11.5 | 1.23 |
| wlc1 (added lactose) | 36.8 | 50.8 | 25.8 | 13.1 | 0.90 | 2.4 | 9.5 | 11.4 | 1.31 |
| wlc1 (added lactose) | 36.6 | 51.4 | 25.7 | 13.2 | 0.91 | 2.4 | 9.4 | 11.3 | 0.65 |
| heat treated | | | | | | | | | |
| wlc2 (added lactose + | 37.1 | 50.6 | 25.9 | 13.1 | 0.91 | 2.3 | 9.6 | 11.4 | 1.29 |
| ferrous sulfate) heat | | | | | | | | | |
| treated | | | | | | | | | |
| WLC1 powder | 37.0 | 50.7 | 94.9 | 48.1 | 3.35 | 18.2 | 35.1 | 11.4 | 0.63 |
| WLC2 powder | 36.9 | 51.0 | 94.7 | 48.3 | 3.45 | 18.1 | 34.9 | 11.3 | 1.32 |
| (incl. ferrous sulfate) | | | | | | | | | |

A wet-blended infant formula ‘base’ powder was produced with the same recipe and process as in example 4 with the exception that no wlc powder was added and the lactose addition was reduced from 5.74 kg to 4.64 kg.

The infant formula ‘base’ was used for dry blending with the wlc1 powder and wlc2 powder described in table 5.1. 1 kg of infant formula ‘base’ powder was mixed with 210 g of wlc powder in a plastic bag.

### Results:

The chemical composition of the infant formula base powder is shown in Table 5.2. The infant formula ‘base’ powder has a protein content of only 7.1% compared to 12.2% in the ‘full’ infant formula powder in example 4. The phospholipid content in the infant formula ‘base’ powder is 0.04% and much lower compared to the 0.45% PL in ‘full’ infant formula in example 4. Most of the other components was slightly increased in the infant formula ‘base’ powder compared to infant formula powder in example 4. No native IgG and LF was detected in the infant formula ‘base’ powder.

The two dry blended infant formula powders have overall the same chemical composition as the wet-blended infant powder in Example 4 (see Tables 5.2 and 5.3). The phospholipid content is higher in the two dry-blended powders 0.61% compared to 0.45% in the wet-blended powder in Example 4. The native IgG is 0.69% (5.8% of protein) in both dry blend infant formula powders and much higher than in the wet-blended infant formula powder in Example 4. The higher content of native LF in the wlc powder added ferrous sulphate also caused a higher native LF in the dry-blended infant formula, 0.08% LF (0.67% LF of protein) in infant formula with ferrous sulphate added to wlc vs 0.038% LF (0.32% LF of protein) with only lactose added to the wlc.

### Conclusion:

Denaturation of native IgG and LF can be reduced to a low level by reducing the heat treatment of the whey raw material to 63 °C for 15 sec. The level of phospholipid of 7.1%/TS in the wlc is higher than the wlc used in example 4 and similarly the content of native IgG and LF is also higher, because IgG and LF is concentrated together with phospholipids (and fat) in the described wlc process.

When lactose is added to the wlc before the ‘dry blend’-quality heat treatment, then native IgG is conserved in the resulting ‘dry-blend’ wlc powder. Adding lactose and ferrous sulphate before heat treatment of the wlc also caused a fully conservation of the native LF in the resulting wlc powder. The amount of ferrous sulphate in the 210 g of wlc2 powder is around 80% of the ferrous sulphate in the 1 kg of infant formula base powder. In order to get the same ferrous sulphate content in the final dry blended infant formula, then the addition of ferrous sulfate to the ‘base’ powder infant formula must be reduced accordingly. The effect of ferrous sulphate on LF heat stability might be explained by a 100% saturation of LF with ferro iron is turning the lactoferrin into a more heat stable molecule.

Dry blending of the two wlc powders with the infant formula ‘base’ powder gave an infant formula with overall the same chemical composition as the wet-blended infant described in example 4, but with much higher content of native IgG and native LF.

The inventors furthermore observed in other experiments that the present heat-treatment regime in combination with a prior MF-based germ filtration offered sufficient microbial reduction to allow for the production of “dry-blend quality” whey lipid powders, i.e. powders with a low total plate count and in which Cronobacter species, Salmonella species and Enterobacteriaceae species are absent.

TABLE 5.2
Compositions involved when dry blending 1 kg of infant formula ‘base’
powder with 210 g of the wlc1 powder (no added iron(II))

| | | “Dry blend”- | |
|---|---|---|---|
| | | quality | Dry blended |
| | Infant formula | ‘Bioactive’ | Infant |
| | ‘base’ powder | wlc1 powder | formula powder |
| Total solids % | 95.1 | 94.9 | 95.1 |
| protein % | 7.1 | 35.1 | 12.0 |
| lactose % | 50.1 | 48.1 | 49.8 |
| fat % | 29.5 | 18.2 | 27.5 |
| Phospholipid % | 0.04 | 3.4 | 0.61 |
| ash % | 2.30 | | 2.1 |
| Phosphorous % | 0.23 | | 0.24 |
| Na % | 0.15 | | 0.13 |
| Mg % | 0.044 | | 0.042 |
| K % | 0.65 | | 0.57 |
| Cl % | 0.37 | | 0.32 |
| Ca % | 0.37 | | 0.34 |
| pH | 6.72 | | 6.69 |
| LF g per 100 g | 0 | 0.22 | 0.038 |
| LF % of total protein | | 0.63 | 0.32 |
| IgG g per 100 g | 0 | 4.0 | 0.69 |
| IgG % of total protein | | 11.4 | 5.8 |

TABLE 5.3
Compositions involved when dry blending 1 kg of infant formula ‘base’
powder with 210 g of wlc2 powder (including added iron(II))

| | | “Dry blend”- | |
|---|---|---|---|
| | | quality - | Dry blended |
| | Infant formula | ‘Bioactive’ | Infant |
| | ‘base’ powder | wlc1 powder | formula powder |
| Total solids % | 95.1 | 94.7 | 95.1 |
| protein % | 7.1 | 34.9 | 12.0 |
| lactose % | 50.1 | 48.3 | 49.8 |
| fat % | 29.5 | 18.1 | 27.5 |
| Phospholipid % | 0.04 | 3.5 | 0.61 |
| ash % | 2.30 | n.d. | 2.1 |
| Phosphorous % | 0.23 | n.d. | 0.24 |
| Na % | 0.15 | n.d. | 0.13 |
| Mg % | 0.044 | n.d. | 0.042 |
| K % | 0.65 | n.d. | 0.57 |
| Cl % | 0.37 | n.d. | 0.32 |
| Ca % | 0.37 | n.d. | 0.34 |
| pH | 6.72 | n.d. | 6.69 |
| LF g per 100 g | 0 | 0.46 | 0.080 |
| LF % of total protein | | 1.32 | 0.67 |
| IgG g per 100 g | 0 | 3.9 | 0.68 |
| IgG % of total protein | | 11.3 | 5.6 |

### Example 6-Production of a ‘Dry Blend’-Quality, Powdered ‘Bioactive’ Whey-Derived Composition Enriched with Respect to Whey Lipids

A liquid whey lipid concentrate (pre-wlc) was prepared as in Example 1. The wlc subjected to heat-treatment was prepared by diluting the pre-wlc with demineralized water to a TS content of approx. 8% w/w.

The wlc was then subject to a pre-heating on tubular and plate heat exchangers to 58 °C followed by a heat treatment of 74.5 °C on a steam infusion unit at a flowrate of 10.000 kg/hr and a holding cell providing a holding time of 30 seconds, and finally flash cooled to 58 °C in a flash vessel. The duration of the temperature ramp-up phase from 58 °C to 74.5 °C was less than 0.5 second and the duration of the cooling step (from 74.5 °C to 58 °C) was less than 0.5 second.

The cooled wlc was then subjected to evaporation at 58 °C using a falling film evaporator to reach a total solids content of approx. 23% w/w. The concentrated wlc was finally dried on a MSD type spray dryer followed by a vibrating fluid bed dryer.

The obtained wlc powder (a whey derived powder enrich with respect to whey lipids) was subjected to a range of chemical and microbial analyses to characterise the powder.

### Results:

The contents of selected nutrients, chemical components and microorganisms of the wlc powder are shown in Table 6.1.

TABLE 6.1
Contents of selected nutrients, chemical
components and microorganisms

| Component | Content | |
|---|---|---|
| Protein | 71.5 | % of total powder weight |
| Fat | 18.7 | % of total powder weight |
| Moisture | 3.4 | % of total powder weight |
| Protein | 74.0 | % of total powder weight |
| Total solids | 96.6 | % of total powder weight |
| Ash value | 2.1 | % of powder weight |
| pH | 6.6 | |
| Native immunoglobin G | 8.5 | % of total protein |
| Lactoferrin | 0.14 | % of total protein |
| Lactose | 0.8 | % of total powder weight |
| Phospholipids | 7.7 | % of total solids |
| Total Plate Count 30 °C | 4000 | cfu/100 g |
| Cronobacter | Not present | in 300 g powder |
| Salmonella species | Not present | in 1500 g powder |
| Enterobacteriaceae species | Not present | in 100 g powder |

### Conclusion:

The processing of wlc including heat treatment by steam infusion was successful in producing microbiologically safe “dry-blend grade” wlc powders while retaining high amounts of native IgG (8.5% w/w of total protein) and LF (0.14% w/w of total protein)—even if only low concentrations of carbohydrate were present during the heat-treatment step.

The inventors have furthermore found that omitting the evaporation step leads to even higher concentrations of native IgG and LF.

1. A method of preparing a whey-derived powder enriched with respect to whey lipid, which whey-derived powder is suitable for preparation of an infant formula powder by dry-blending, the method comprising the steps of:
a) providing a non-sterile whey lipid concentrate, the whey lipid concentrate having:
a content of phospholipid of at least 1.5% w/w relative to total solids (TS),
a weight ratio between phospholipid and total protein of at least 0.04,
a content of carbohydrate of at most 70% w/w relative to TS,
a total solids content of 1-50% w/w,
preferably, a content of native immunoglobulin G of 1-17% w/w relative to total protein,
preferably, a content of native lactoferrin of 0.1-1.5% w/w relative to total protein, and
b) subjecting the whey lipid concentrate to heat-treatment involving heating the whey lipid concentrate to a target temperature in the range of 63-160 °C with a holding time sufficient to provide at least some microbial reduction,
c) drying a liquid composition comprising at least lipid and protein of the heat-treated whey lipid concentrate obtained from step b).

2. The method according to claim 1 wherein:
the whey lipid concentrate comprises lactose in an amount of 25-70% w/w TS, and/or
the heat-treatment of step b) involves heating by direct heating, preferably involving heating by steam infusion, and preferably wherein any heating performed when the whey lipid concentrate has a temperature above 63 °C is performed by direct heating, preferably by steam infusion.

3. The method according to any one of the preceding claims, wherein the whey lipid concentrate has a weight ratio between phospholipid and total lipid of 0.20-0.50, more preferably 0.25-0.45, and most preferably 0.30-0.40.

4. The method according to any one of the preceding claims, wherein the whey lipid concentrate has a weight ratio between phospholipid and total protein in the range of 0.04-0.25, more preferably 0.07-0.20, even more preferably 0.08-0.17, and most preferably 0.09-0.15.

5. The method according to any one of the preceding claims wherein the whey lipid concentrate comprises carbohydrate in an amount of 25-70% w/w TS, more preferably 35-70% w/w TS, and most preferably 40-70% w/w TS.

6. The method according to any one of the preceding claims wherein the whey lipid concentrate comprises carbohydrate in an amount of less than 25% w/w TS, more preferably at most 15% w/w TS, even more preferably at most 6% w/w TS, and most preferably at most 2% w/w TS.

7. The method according to any one of the preceding claims wherein the whey lipid concentrate has a content of native immunoglobulin G of 5-17% w/w relative to total protein, more preferably 7-16% w/w, even more preferably 8-15% w/w, and most preferably 10-15% w/w relative to total protein.

8. The method according to any one of the preceding claims wherein the whey lipid concentrate has the weight ratio between native immunoglobulin G and total immunoglobulin G of at least 0.5, more preferably at least 0.7, even more preferably at least 0.8, and most preferably at least 0.9.

9. The method according to any one of the preceding claims wherein the whey lipid concentrate has a content of native lactoferrin of 0.1-1.2% w/w relative to total protein, more preferably 0.2-1.2% w/w, even more preferably 0.3-1.2% w/w, and most preferably 0.3-1.1% w/w relative to total protein.

10. The method according to any one of the preceding claims wherein the whey lipid concentrate has a content of native lactoferrin of 0.2-1.5% w/w relative to total protein, more preferably 0.3-1.5% w/w, even more preferably 0.4-1.5% w/w, and most preferably 0.5-1.5% w/w relative to total protein.

11. The method according to any one of the preceding claims wherein the whey lipid concentrate has a weight ratio between native lactoferrin and total lactoferrin of at least 0.3, more preferably at least 0.4, even more preferably at least 0.5, and most preferably at least 0.6.

12. The method according to any one of the preceding claims, wherein the whey lipid concentrate comprises total solids in an amount of 2-25% w/w, more preferably 5-20%, even more preferably 8-20% w/w, and most preferably 10-18% w/W.

13. The method according to any one of the preceding claims, wherein the whey lipid concentrate has a content of Fe(II) in an amount of 2-50 mg per kg protein, more preferably 3-30 mg per kg protein, even more preferably 4-15 mg per kg protein, and most preferably 5-10 mg per kg protein.

14. The method according to any one of the preceding claims wherein the heat-treatment of step b) involves direct heating, and preferably indirect heating followed by direct heating.

15. The method according to claim 14 wherein the direct heating involve one of more of heating via steam infusion, direct steam injection, ohmic heating, and microwave heating.

16. The method according to any one of the preceding claims wherein any heating performed when the whey lipid concentrate has a temperature above 60 °C is performed by direct heating, preferably by steam infusion.

17. The method according to any one of the preceding claims wherein at least 50% of the denaturation of lactoferrin during step b) occurs at the target temperature, more preferably at least 60%, even more preferably at least 70%, and most preferably at least 80% of the denaturation of lactoferrin during step b).

18. The method according to any one of the preceding claims wherein the target temperature of the heat-treatment of step b) is in the range 70-75 °C and the holding time is the range of 1-60 seconds.

19. A whey-derived powder enriched with respect to whey lipid, the whey-derived powder having:
a content of phospholipid of at least 1.5% w/w relative to total solids,
a weight ratio between phospholipid and total protein of at least 0.04,
a content of carbohydrate of at most 70% w/w relative to TS, preferably wherein lactose comprises at least 50% w/w of the carbohydrate,
a total solids content of at least 92% w/w,
preferably, a content of native immunoglobulin G of 1-17% w/w relative to total protein,
preferably, a content of native lactoferrin of 0.1-1.5% w/w relative to total protein, said whey-derived powder having one or more of, and more preferably all of, the following characteristics:
a total plate count of at most 1000000 CFU/100 g the whey-derived powder,
Cronobacter species are absent in at least 30 samples of 10 g of the whey-derived powder,
Salmonella species are absent in at least 30 samples of 25 g of the whey-derived powder, and
Enterobacteriaceae species are absent in at least 10 samples of 10 g of the whey-derived powder.

20. The whey-derived powder according to claim 13 wherein the whey-derived powder comprises carbohydrate in an amount of less than 25% w/w TS, more preferably at most 15% w/w TS, even more preferably at most 6% w/w TS, and most preferably at most 2% w/w TS.

21. The whey-derived powder according to claim 13 wherein the whey-derived powder comprises carbohydrate in an amount of 25-70% w/w TS, more preferably 35-70% w/w TS, and most preferably 40-70% w/w TS.

22. The whey-derived powder according to any one of claims 19-21 wherein the whey-derived powder has a content of native immunoglobulin G of 5-17% w/w relative to total protein, more preferably 7-16% w/w, even more preferably 8-15% w/w, and most preferably 10-15% w/w relative to total protein.

23. The whey-derived powder according to any one of claims 19-22 wherein the whey-derived powder has the weight ratio between native immunoglobulin G and total immunoglobulin G of at least 0.5, more preferably at least 0.7, even more preferably at least 0.8, and most preferably at least 0.9.

24. The whey-derived powder according to any one of claims 19-23 wherein the whey-derived powder has a content of native lactoferrin of 0.1-1.2% w/w relative to total protein, more preferably 0.2-1.2% w/w, even more preferably 0.3-1.2% w/w, and most preferably 0.3-1.1% w/w relative to total protein.

25. The whey-derived powder according to any one of claims 19-24 wherein the whey-derived powder has a content of native lactoferrin of 0.2-1.5% w/w relative to total protein, more preferably 0.3-1.5% w/w, even more preferably 0.4-1.5% w/w, and most preferably 0.5-1.5% w/w relative to total protein.

26. The whey-derived powder according to any one of claims 19-25 wherein the whey-derived powder has a weight ratio between native lactoferrin and total lactoferrin of at least 0.3, more preferably at least 0.4, even more preferably at least 0.5, and most preferably at least 0.6.

27. Use of the whey-derived powder according to one or more of claims 19-26 as a food ingredient, for preparing a nutritional product, preferably for paediatric nutrition, and more preferably an infant formula product in powder form,
preferably wherein the nutritional product is prepared by dry-blending the whey-derived powder according to one or more of claims 19-26 with:
one or more additional powder ingredient(s), and
optionally, further powder ingredient comprising of probiotic bacteria.

28. Use according to claim 27 wherein the whey-derived powder is used in an amount sufficient to contribute with at least 25% w/w of the total amount of the phospholipid of the nutritional powder, more preferably at least 40% w/w, even more preferably at least 50% w/w, and more preferably at least 60% w/w of the total amount of the phospholipid of the nutritional powder.

29. A process of producing a nutritional powder, preferably for paediatric nutrition, and more preferably an infant formula, the process comprising dry-blending the whey-derived powder according to one or more of claims 19-26 with:
one or more additional powder ingredient(s), and
optionally, a further powder ingredient comprising of probiotic bacteria,
wherein the one or more additional powder ingredient(s) have the following characteristics:
a total plate count of at most 1000000 CFU/100 g ingredient powder, and more preferably at most 50000 CFU/100 g ingredient powder,
Cronobacter species are absent in at least 30 samples of 10 g ingredient powder,
Salmonella species are absent in at least 30 samples of 25 g ingredient powder, and
Enterobacteriaceae species are absent in at least 10 samples of 10 g ingredient powder.

30. The process according to claim 29 wherein the whey-derived powder is used in an amount sufficient to contribute with at least 25% w/w of the total amount of the phospholipid of the nutritional powder, more preferably at least 40% w/w, even more preferably at least 50% w/w, and more preferably at least 60% w/w of the total amount of the phospholipid of the nutritional powder.

31. A nutritional powder which is a dry-blend of the whey-derived powder according to one or more of claims 19-26 and one or more additional powder ingredient(s), and optionally a further powder ingredient comprising of probiotic bacteria,
preferably wherein the combination of the one or more additional ingredients have the following characteristics:
a total plate count of at most 1000000 CFU/100 g ingredient powder, and more preferably at most 50000 CFU/100 g ingredient powder,
Cronobacter species are absent in at least 30 samples of 10 g ingredient powder,
Salmonella species are absent in at least 30 samples of 25 g ingredient powder, and
Enterobacteriaceae species are absent in at least 10 samples of 10 g ingredient powder.

32. The nutritional powder according to claim 31 in the form of a paediatric food product and more preferably an infant formula, a follow-on formula or a growing-up formula.

33. The nutritional powder according to claim 31 or 32 wherein the whey-derived powder is present in an amount sufficient to contribute with at least 25% w/w of the total amount of the phospholipid of the nutritional powder, more preferably at least 40% w/w, even more preferably at least 50% w/w, and more preferably at least 60% w/w of the total amount of the phospholipid of the nutritional powder.
